(19) United States
(12) Patent Application Publication
(10) Pub. No.: US 2020/0328390 A1
(43) Pub. Date: Oct. 15, 2020

(54) SEPARATORS FOR LEAD-ACID BATTERIES

(71) Applicant: Hollingsworth & Vose Company, East Walpole, MA (US)

(72) Inventors: Praveen Yegya Raman Kumar, Nashua, NH (US); Nicolas Clement, Littleton, MA (US); Howard Yu, Belmont, MA (US)

(73) Assignee: Hollingsworth & Vose Company, East Walpole, MA (US)

(21) Appl. No.: 16/382,901

(22) Filed: Apr. 12, 2019

(51) Int. Cl. H01M 2/16; H01M 10/12

(52) U.S. Cl. CPC H01M 2/1606; H01M 10/12

(57) ABSTRACT

Battery separators and lead-acid batteries comprising battery separators are generally provided. The battery separators may have one or more features that enhances their suitability for use in lead-acid batteries. For example, the battery separators described herein may have one or more features that enhance their suitability for emerging flooded battery applications, such as extended flooded battery applications.

### FIELD

The present invention relates generally to separators for batteries, and, more particularly, to separators for lead-acid batteries.

### BACKGROUND

Separators are typically employed in batteries to separate the battery plates therein. However, many such separators are undesirable for emerging lead-acid battery applications for a number of reasons. For instance, such separators may leach contaminants into the electrolyte, may be less mechanically robust than desired, and/or may include pores in sizes and/or amounts that inhibit the flow of electrolyte therethrough. Accordingly, improved separator designs are needed.

### SUMMARY

Battery separators, related components, and related methods are generally described.

In some embodiments, a lead-acid battery comprising a battery separator and a battery plate is provided. The battery separator comprises a non-woven fiber web comprising synthetic fibers making up greater than 80 wt % of the non-woven fiber web. The synthetic fibers comprise non-continuous fibers having an average length of greater than or equal to 0.1 mm and less than or equal to 300 mm. The battery separator has an apparent density of greater than or equal to 40 gsm/mm and less than or equal to 200 gsm/mm, a porosity of greater than or equal to 70%, and a mean flow pore size of greater than or equal to 1 micron and less than or equal to 15 microns.

In some embodiments, a lead-acid battery comprising a battery separator and a battery plate is provided. The battery separator comprises a non-woven fiber web comprising synthetic fibers. The synthetic fibers comprise non-continuous fibers having an average length of greater than or equal to 0.1 mm and less than or equal to 300 mm. The battery separator has a puncture strength of greater than 20 N, a porosity of greater than or equal to 70%, and a mean flow pore size of greater than or equal to 1 micron and less than or equal to 15 microns.

In some embodiments, a lead-acid battery comprising a battery separator and a battery plate is provided. The battery separator comprises a non-woven fiber web comprising synthetic fibers. The synthetic fibers comprise non-continuous fibers having an average length of greater than or equal to 0.1 mm and less than or equal to 300 mm. The battery separator comprises fibrillated fibers. The battery separator has a porosity of greater than or equal to 70% and a mean flow pore size of greater than or equal to 1 micron and less than or equal to 15 microns.

In some embodiments, a lead-acid battery comprising a battery separator and a battery plate is provided. The battery separator comprises a non-woven fiber web comprising synthetic fibers making up greater than 80 wt % of the non-woven fiber web. The synthetic fibers comprise non-continuous fibers having an average length of greater than or equal to 0.1 mm and less than or equal to 300 mm. The synthetic fibers comprise multicomponent fibers. The battery separator has a porosity of greater than or equal to 70% and a mean flow pore size of greater than or equal to 1 micron and less than or equal to 15 microns.

In some embodiments, a battery separator is provided. The battery separator comprises a non-woven fiber web comprising synthetic fibers. The synthetic fibers comprise non-continuous fibers having an average length of greater than or equal to 0.1 mm and less than or equal to 300 mm. The battery separator has a porosity of greater than or equal to 70% and a mean flow pore size of greater than or equal to 1 micron and less than or equal to 15 microns. The battery separator is a pocket separator.

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is a schematic depiction of a battery separator, in accordance with some embodiments;

FIG. 2 is a schematic depiction of a battery separator comprising two layers, in accordance with some embodiments;

FIG. 3 is a schematic depiction of a folded separator, in accordance with some embodiments;

FIG. 4 is a schematic depiction of a folded separator folded around a battery plate, in accordance with some embodiments;

FIG. 5 is a schematic depiction of a pocket separator, in accordance with some embodiments;

FIGS. 6A-6D are schematic depictions of battery separators comprising protrusions and depressions, in accordance with some embodiments; and

FIG. 7 is a schematic depiction of a lead-acid battery, in accordance with some embodiments.

### DETAILED DESCRIPTION

Battery separators, and lead-acid batteries comprising battery separators, are generally provided. In some embodiments, the battery separators described herein have one or more features that enhance their suitability for emerging flooded battery applications, such as extended flooded battery applications. Extended flooded batteries are typically operated at harsher conditions than other types of lead-acid batteries, and so battery separators that can withstand these harsher environments are advantageous for use therein.

By way of example, battery separators that include a combination of components that do not leach appreciable contaminants (e.g., due to oxidation in the battery) into electrolytes during flooded battery operation may be desirable for use in these batteries. Examples of such components may include non-continuous synthetic fibers (e.g., staple fibers), fibrillated fibers, crimped fibers, and multicomponent fibers. Some battery separators suitable for use in flooded batteries may comprise minimal or no components that leach appreciable contaminants into the electrolyte during extended flooded battery operation, such as minimal or no extruded components and/or minimal or no components that undergo appreciable oxidation under the conditions at which flooded batteries are operated. Some battery separator may comprise relatively low amounts of such contaminants, such as relatively low amounts of solvents and/or mineral oil (e.g., relatively low amounts of alkanes and/or fatty acids). For instance, in some embodiments, a battery separator is substantially free of solvents and mineral oil (e.g., substantially free of alkanes and/or fatty acids).

As another example, battery separators may exhibit one or more mechanical properties indicative of a resistance to deformation and/or failure. This may be desirable in the case of flooded batteries, such as extended flooded batteries, comprising one or more components that may have sharp protrusions (e.g., battery plates comprising metal grids having sharp protrusions). Resistance to deformation and puncture upon contact with such sharp protrusions may advantageously allow the battery separator to be present in a battery comprising such sharp protrusions without undergoing mechanical failure. This may desirably improve the lifetime and/or robustness of extended flooded batteries in which these battery separators are positioned. Some battery separators may have other mechanical properties advantageous for use in flooded battery applications, such as resistance to abrasion, resistance to scuffing, and/or reduced brittleness.

As a third example, battery separators may be particularly robust at elevated temperatures. Flooded batteries may operate at high temperatures (such as those present in hot climates and/or car engines), and so battery separators that do not melt and/or appreciably deform at these operating temperatures are desirable. Battery separators configured to be robust at elevated temperatures may include minimal or no components that melt at low temperature (e.g., resin). In some embodiments, a battery separator includes multicomponent fibers to bond together the battery separator (e.g., instead of all or a portion of the resin that would otherwise be used). Portions of the multicomponent fibers may have melting points above the temperatures at which the extended flooded batteries operate.

As a fourth example, battery separators may have a morphology particularly suited for use in flooded battery applications, such as extended flooded battery applications. The battery separators may both have a relatively large open volume (which may allow electrolyte flow therethrough with reduced resistance) and include solid components sufficiently spaced to arrest and/or slow dendrite growth therethrough. These features may be combined in a single battery separator by designing the battery separator to have a high porosity but a small pore size and/or to include pores that are relatively tortuous. It is believed that fibrillated fibers may be particularly suitable for forming such a battery separator, as the fibrillated fibers form fibrils that reduce the pore size while not appreciably reducing the pore volume. As another configuration, a battery separator may have a three-dimensional structure that causes it to have the desirably low pore size and also have a relatively large open volume (including pores and/or spaces between different portions of the battery separator, such as depressions therein and/or spaces between protrusions therein). In some embodiments, a battery separator has a relatively low apparent density, which may be indicative of a relatively large open volume.

In some embodiments, the battery separators described herein and/or batteries including such separators may include one or more of the features and advantages described above. It should be understood that different battery separators will be suitable for different types of lead-acid battery applications and that not all embodiments described herein will have each of the above-referenced advantageous features. Some battery separators described herein may have a subset of such features, or may be suitable for use in flooded lead-acid batteries for other reasons. It should also be understood that some battery separators described herein may have one or more of the above-referenced features but may be configured for use in, or employed in, batteries of other types than flooded lead-acid batteries.

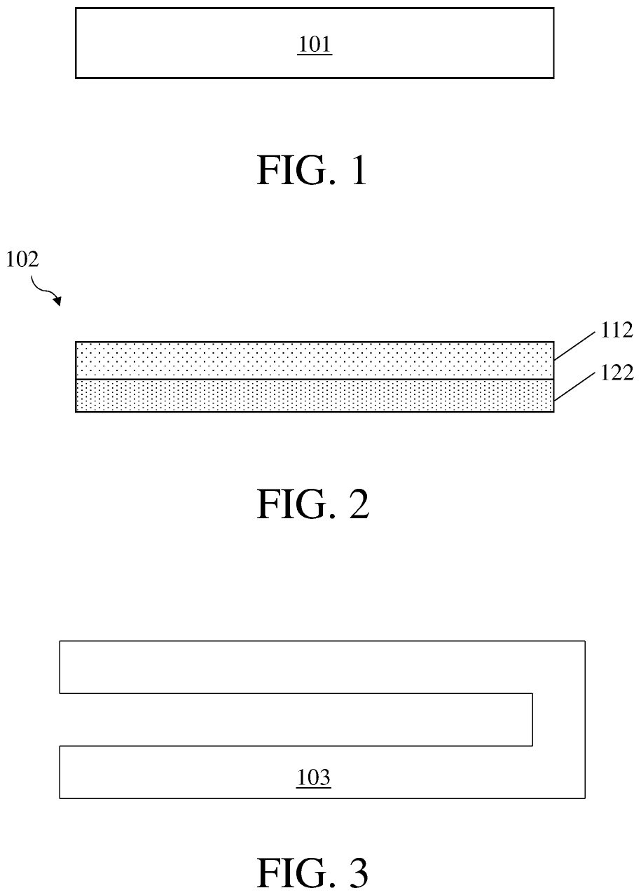

As described above, some embodiments relate to battery separators. FIG. 1 shows one non-limiting embodiment of a battery separator 101. In some embodiments, a battery separator is a single layer battery separator (e.g., it may include a single layer that is fiber web). In other embodiments, a battery separator comprises two or more layers. For instance, FIG. 2 shows one non-limiting embodiment of a two layer battery separator 102 comprising a first layer 112 and a second layer 122. The first and second layers may be identical, may be of the same type but differ in one or more ways (e.g., a battery separator may include two fiber webs that have different porosities and/or include different types of fibers), or may be of different types.

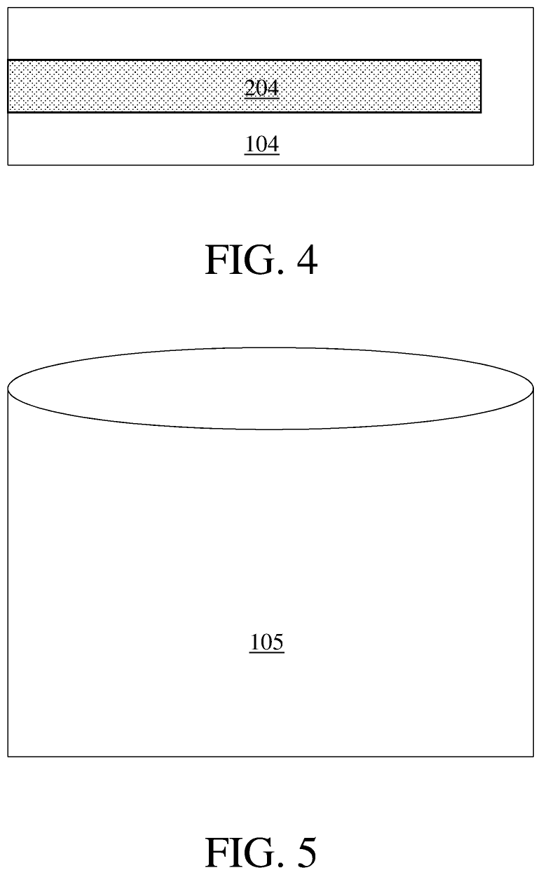

The battery separators described herein may have a variety of suitable designs. In some embodiments, like the embodiments shown in FIGS. 1 and 2, the battery separator is a leaf separator. Other suitable types of battery separators include, but are not limited to, folded separators, pocket separators, z-fold separators, sleeve separators, corrugated separators, C-wrap separators, and U-wrap separators. FIG. 3 shows one non-limiting embodiment of a folded separator 103, which may be folded around a battery plate when positioned in a lead-acid battery. This configuration is shown in FIG. 4, in which a folded separator 104 is folded around a battery plate 204. FIG. 5 shows one non-limiting embodiment of a pocket separator 105, which is sealed on three sides and is open on the final side. A battery plate may be positioned inside the pocket formed by this separator when positioned in a lead-acid battery (not shown).

Without wishing to be bound by any particular theory, in some cases it may be challenging to fabricate battery separators other than leaf separators (e.g., folded separators, pocket separators) from materials that are relatively stiff. Accordingly, in embodiments in which such battery separators are desirable, it may be advantageous to include a relatively high amount of flexible components (e.g., synthetic fibers, natural fibers) and/or a relatively low amount of stiff components (e.g., glass fibers). Regarding pocket separators in particular, it is often desirable to form the pocket separator by first forming a flat sheet, then folding the flat sheet, and finally bonding the edges of the folded sheet together. This is frequently accomplished by the application of heat to melt a component of the flat sheet at the edges such that a thermal bond is formed along the edges of the folded sheet. Accordingly, it may be desirable for pocket separators to include one or more components that may be melt bonded, such as multicomponent fibers.

As described elsewhere herein, a battery separator may comprise one or more fiber webs. The fiber web(s) may be non-woven fiber web(s), such as a wetlaid non-woven fiber web(s), non-wetlaid non-woven fiber webs (e.g., drylaid non-woven fiber web(s), such as carded non-woven fiber web(s)). The fiber web(s) may also be calendered non-woven fiber web(s). In some embodiments, a fiber web has one or more features imparting a physical property to the separator that makes it advantageous for use in lead-acid batteries. For instance, a fiber web may have a structure that allows appropriate electrolyte flow therethrough and/or is sufficiently mechanically and/or chemically robust to not undergo appreciable degradation and/or leach appreciable components into batteries when employed in advanced lead-acid applications.

When present, a fiber web may include a variety of suitable types of fibers. In some embodiments, a fiber web comprises synthetic fibers. A variety of suitable synthetic fibers may be employed in the fiber webs described herein. For instance, a fiber web may comprise one or more of the following types of synthetic fibers: poly(olefin) fibers (e.g., poly(propylene) fibers, poly(ethylene) fibers), acrylic fibers (e.g., dryspun acrylic fibers, modacrylic fibers, wetspun acrylic fibers), fibers formed from halogenated polymers (e.g., fibers formed from fluorinated polymers, such as poly(vinyl chloride) fibers, poly(tetrafluoroethylene) fibers, poly(vinylidine fluoride) fibers), poly(styrene) fibers, poly(sulfone) fibers, poly(ethersulfone) fibers, poly(carbonate) fibers, nylon fibers, poly(urethane) fibers, fibers comprising a phenolic resin, poly(ester) fibers, poly(aramid) fibers (e.g., para-poly(aramid) fibers, meta-poly(aramid) fibers, Kevlar fibers, Nomex fibers), poly(imide) fibers, poly(phenylene oxide) fibers, poly(phenylene sulfide) fibers, poly(methyl pentene) fibers, poly(ether ketone) fibers, liquid crystal polymeric fibers (e.g., poly(p-phenylene-2,6-benzobisoxazole fibers; poly(ester)-based liquid crystal polymers, such as fibers produced by the polycondensation of 4-hydroxybenzoic acid and 6-hydroxynaphthalene-2-carboxylic acid), regenerated cellulose, celluloid, cellulose acetate, and carboxymethylcellulose. The synthetic fibers may comprise non-continuous synthetic fibers, staple synthetic fibers, fibrillated synthetic fibers, non-fibrillated synthetic fibers, crimped synthetic fibers, uncrimped synthetic fibers, monocomponent synthetic fibers, and/or multicomponent synthetic fibers (e.g., bicomponent synthetic fibers). In embodiments in which more than one fiber web is present, each fiber web may independently comprise synthetic fibers comprising one or more of the types of fibers described above.

When present therein, the total amount of synthetic fibers may make up a relatively large percentage of a fiber web. For instance, in some embodiments, a fiber web comprises a total amount of synthetic fibers that make up greater than 80 wt %, greater than or equal to 85 wt %, greater than or equal to 90 wt %, or greater than or equal to 95 wt % of the fiber web. In some embodiments, a fiber web comprises a total amount of synthetic fibers that make up less than or equal to 100 wt %, less than or equal to 95 wt %, less than or equal to 90 wt %, or less than or equal to 85 wt % of the fiber web. Combinations of the above-referenced ranges are also possible (e.g., greater than 80 wt % and less than or equal to 100 wt % of the fiber web). In some embodiments, synthetic fibers make up 100 wt % of the fiber web. Other ranges are also possible. In embodiments in which more than one fiber web is present, each fiber web may independently comprise a total amount of synthetic fibers in one or more of the amounts described above.

In some embodiments, the synthetic fibers (e.g., the ones listed above) are non-continuous synthetic fibers (e.g., staple fibers). The non-continuous synthetic fibers may comprise fibers formed by a process that involves cutting continuous filaments to shorter lengths. In some embodiments, a fiber web comprises groups of non-continuous synthetic fibers (e.g., staple fibers) cut to have a particular length with only slight variations in length between individual fibers. The non-continuous synthetic fibers may comprise fibrillated fibers, non-fibrillated fibers, crimped fibers, and/or uncrimped fibers.

When and if present in a fiber web, synthetic fibers (e.g., non-fibrillated synthetic fibers, non-continuous synthetic fibers, synthetic staple fibers, crimped synthetic fibers, uncrimped synthetic fibers) in the fiber web may have an average fiber length of greater than or equal to 0.1 mm, greater than or equal to 0.2 mm, greater than or equal to 0.5 mm, greater than or equal to 1 mm, greater than or equal to 2 mm, greater than or equal to 5 mm, greater than or equal to 10 mm, greater than or equal to 15 mm, greater than or equal to 20 mm, greater than or equal to 25 mm, greater than or equal to 30 mm, greater than or equal to 38 mm, greater than or equal to 40 mm, greater than or equal to 45 mm, greater than or equal to 50 mm, greater than or equal to 55 mm, greater than or equal to 60 mm, greater than or equal to 65 mm, greater than or equal to 70 mm, greater than or equal to 76 mm, greater than or equal to 80 mm, greater than or equal to 85 mm, greater than or equal to 90 mm, greater than or equal to 100 mm, greater than or equal to 125 mm, greater than or equal to 150 mm, greater than or equal to 175 mm, greater than or equal to 200 mm, or greater than or equal to 250 mm. The synthetic fibers (e.g., non-fibrillated synthetic fibers, non-continuous synthetic fibers, synthetic staple fibers, crimped synthetic fibers, uncrimped synthetic fibers) in the fiber web may have an average fiber length of less than or equal to 300 mm, less than or equal to 250 mm, less than or equal to 200 mm, less than or equal to 175 mm, less than or equal to 150 mm, less than or equal to 125 mm, less than or equal to 100 mm, less than or equal to 90 mm, less than or equal to 85 mm, less than or equal to 80 mm, less than or equal to 76 mm, less than or equal to 70 mm, less than or equal to 65 mm, less than or equal to 60 mm, less than or equal to 55 mm, less than or equal to 50 mm, less than or equal to 45 mm, less than or equal to 40 mm, less than or equal to 38 mm, less than or equal to 30 mm, less than or equal to 25 mm, less than or equal to 20 mm, less than or equal to 15 mm, less than or equal to 10 mm, less than or equal to 5 mm, less than or equal to 2 mm, less than or equal to 1 mm, less than or equal to 0.5 mm, or less than or equal to 0.2 mm. Combinations of the above-referenced ranges are also possible (e.g., greater than or equal to 0.1 mm and less than or equal to 300 mm, greater than or equal to 1 mm and less than or equal to 100 mm, or greater than or equal to 38 mm and less than or equal to 76 mm). Other ranges are also possible.

In embodiments in which more than one fiber web comprising synthetic fibers is present, each fiber web comprising synthetic fibers may independently comprise synthetic fibers (e.g., non-fibrillated synthetic fibers, non-continuous synthetic fibers, synthetic staple fibers, crimped synthetic fibers, uncrimped synthetic fibers) having an average length in one or more of the ranges described above. In embodiments in which a fiber web comprises more than one type of synthetic fiber (e.g., crimped synthetic fibers and uncrimped synthetic fibers), each type of synthetic fiber may independently have an average length in one or more of the ranges described above and/or all of the synthetic fibers together may have an average length in one or more of the ranges described above.

Synthetic fibers (e.g., non-fibrillated synthetic fibers, non-continuous synthetic fibers, synthetic staple fibers, crimped synthetic fibers, uncrimped synthetic fibers) included in the fiber webs described herein may have a suitable average diameter. In some embodiments, a fiber web comprises synthetic fibers (e.g., non-fibrillated synthetic fibers, non-continuous synthetic fibers, synthetic staple fibers, crimped synthetic fibers, uncrimped synthetic fibers) having an average diameter of greater than or equal to greater than or equal to 0.1 micron, greater than or equal to 0.2 microns, greater than or equal to 0.5 microns, greater than or equal to 1 micron, greater than or equal to 2 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, or greater than or equal to 40 microns. In some embodiments, a fiber web comprises synthetic fibers (e.g., non-fibrillated synthetic fibers, non-continuous synthetic fibers, synthetic staple fibers, crimped synthetic fibers, uncrimped synthetic fibers) having an average diameter of less than or equal to 50 microns, less than or equal to 40 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2 microns, less than or equal to 1 micron, less than or equal to 0.5 microns, or less than or equal to 0.2 microns. Combinations of the above-referenced ranges are also possible (e.g., greater than or equal to 0. 1 micron and less than or equal to 50 microns, greater than or equal to 1 micron and less than or equal to 20 microns, or greater than or equal to 5 microns and less than or equal to 15 microns). Other ranges are also possible.

In embodiments in which more than one fiber web comprising synthetic fibers is present, each fiber web comprising synthetic fibers may independently comprise synthetic fibers (e.g., non-fibrillated synthetic fibers, non-continuous synthetic fibers, synthetic staple fibers, crimped synthetic fibers, uncrimped synthetic fibers) having an average diameter in one or more of the ranges described above. In embodiments in which a fiber web comprises more than one type of synthetic fiber (e.g., crimped synthetic fibers and uncrimped synthetic fibers), each type of synthetic fiber may independently have an average diameter in one or more of the ranges described above and/or all of the synthetic fibers together may have an average diameter in one or more of the ranges described above.

Synthetic fibers (e.g., non-fibrillated synthetic fibers, non-continuous synthetic fibers, synthetic staple fibers, crimped synthetic fibers, uncrimped synthetic fibers) included in the fiber webs described herein may have a suitable average aspect ratio. In some embodiments, a fiber web comprises synthetic fibers (e.g., non-fibrillated synthetic fibers, non-continuous synthetic fibers, synthetic staple fibers, crimped synthetic fibers, uncrimped synthetic fibers) having an average aspect ratio of greater than or equal to 200, greater than or equal to 300, greater than or equal to 400, greater than or equal to 500, greater than or equal to 750, greater than or equal to 1000, greater than or equal to 2000, greater than or equal to 3000, greater than or equal to 4000, greater than or equal to 5000, or greater than or equal to 7500. In some embodiments, a fiber web comprises synthetic fibers (e.g., non-fibrillated synthetic fibers, non-continuous synthetic fibers, synthetic staple fibers, crimped synthetic fibers, uncrimped synthetic fibers) having an average aspect ratio of less than or equal to 10000, less than or equal to 7500, less than or equal to 5000, less than or equal to 4000, less than or equal to 3000, less than or equal to 2000, less than or equal to 1000, less than or equal to 750, less than or equal to 500, less than or equal to 400, or less than or equal to 300. Combinations of the above-referenced ranges are also possible (e.g., greater than or equal to 200 and less than or equal to 10000). Other ranges are also possible.

In embodiments in which more than one fiber web comprising synthetic fibers is present, each fiber web comprising synthetic fibers may independently comprise synthetic fibers (e.g., non-fibrillated synthetic fibers, non-continuous synthetic fibers, synthetic staple fibers, crimped synthetic fibers, uncrimped synthetic fibers) having an average aspect ratio in one or more of the ranges described above. In embodiments in which a fiber web comprises more than one type of synthetic fiber (e.g., crimped synthetic fibers and uncrimped synthetic fibers), each type of synthetic fiber may independently have an average aspect ratio in one or more of the ranges described above and/or all of the synthetic fibers together may have an average aspect ratio in one or more of the ranges described above.

When and if present in a fiber web, non-fibrillated synthetic fibers (e.g., synthetic staple fibers, crimped synthetic fibers, uncrimped synthetic fibers) may make up any suitable percentages thereof. In some embodiments, the non-continuous synthetic fibers (e.g., non-fibrillated synthetic fibers, synthetic staple fibers, crimped synthetic fibers, uncrimped synthetic fibers) make up greater than or equal to 0 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 60 wt %, greater than or equal to 70 wt %, greater than or equal to 80 wt %, or greater than or equal to 90 wt % of the fiber web. The non-fibrillated synthetic fibers (e.g., non-continuous synthetic fibers, synthetic staple fibers, crimped synthetic fibers, uncrimped synthetic fibers) may make up less than or equal to 100 wt %, less than or equal to 90 wt %, less than or equal to 80 wt %, less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, or less than or equal to 5 wt % of the fiber web. Combinations of the above-referenced ranges are also possible (e.g., greater than or equal to 0 wt % and less than or equal to 100 wt % of the fiber web, greater than or equal to 5 wt % and less than or equal to 45 wt % of the fiber web, or greater than or equal to 15 wt % and less than or equal to 35 wt % of the fiber web). Other ranges are also possible. In some embodiments, non-fibrillated synthetic fibers (e.g., synthetic staple fibers, crimped synthetic fibers, uncrimped synthetic fibers) make up 100 wt % of the fiber web.

In embodiments in which more than one fiber web is present, each fiber web may independently comprise non-fibrillated synthetic fibers (e.g., synthetic staple fibers, crimped synthetic fibers, uncrimped synthetic fibers) in one or more of the amounts described above. In embodiments in which a fiber web comprises more than one type of non-fibrillated synthetic fiber (e.g., crimped synthetic fibers and uncrimped synthetic fibers), the fiber web may independently comprise each type of non-fibrillated synthetic fiber in one or more of the amounts described above and/or may comprise all of the non-fibrillated synthetic fibers together in one or more of the amounts described above.

In some embodiments, a fiber web comprises fibers that are fibrillated. As known to those of ordinary skill in the art, a fibrillated fiber includes a parent fiber that branches into smaller diameter fibrils, which can, in some instances, branch further out into even smaller diameter fibrils with further branching also being possible. The branched nature of the fibrils may enhance the surface area of a fiber web in which the fibrillated fibers are employed, and can increase the number of contact points between the fibrillated fibers and other fibers in the fiber web. Such an increase in points of contact between the fibrillated fibers and other fibers in the fiber web may enhance the mechanical properties (e.g., flexibility, strength) of the fiber web.

When and if present, the fibrillated fibers may comprise synthetic fibrillated fibers, non-limiting examples of which include poly(ester) fibers, nylon fibers, poly(aramid) fibers (e.g., para-poly(aramid) fibers, meta-poly(aramid) fibers), poly(imide) fibers, poly(olefin) fibers (e.g., poly(ethylene) fibers, poly(propylene) fibers), poly(ether ether ketone) fibers, poly(ethylene terephthalate) fibers, acrylic fibers, liquid crystal polymeric fibers (e.g., poly(p-phenylene-2,6-benzobisoxazole fibers; poly(ester)-based liquid crystal polymers, such as fibers produced by the polycondensation of 4-hydroxybenzoic acid and 6-hydroxynaphthalene-2-carboxylic acid), regenerated cellulose (e.g., lyocell, rayon), celluloid, cellulose acetate, and carboxymethylcellulose. It is also possible for the fibrillated fibers to, alternatively or additionally, comprise natural fibers, such as natural cellulose fibers and/or wool. In embodiments in which more than one fiber web is present, each fiber web may independently comprise fibrillated fibers comprising one or more of the types of fibers described above.

In some embodiments, a fiber web comprises fibrillated fibers that are non-continuous. The fibrillated fibers in the fiber web may have an average fiber length of greater than or equal to 0.1 mm, greater than or equal to 0.2 mm, greater than or equal to 0.3 mm, greater than or equal to 0.4 mm, greater than or equal to 0.5 mm, greater than or equal to 0.75 mm, greater than or equal to 1 mm, greater than or equal to 2 mm, greater than or equal to 3 mm, greater than or equal to 4 mm, greater than or equal to 5 mm, greater than or equal to 7.5 mm, greater than or equal to 10 mm, greater than or equal to 15 mm, greater than or equal to 20 mm, greater than or equal to 25 mm, or greater than or equal to 30 mm. The fibrillated fibers in the fiber web may have an average fiber length of less than or equal to 50 mm, less than or equal to 30 mm, less than or equal to 25 mm, less than or equal to 20 mm, less than or equal to 15 mm, less than or equal to 10 mm, less than or equal to 7.5 mm, less than or equal to 5 mm, less than or equal to 4 mm, less than or equal to 3 mm, less than or equal to 2 mm, less than or equal to 1 mm, less than or equal to 0.75 mm, less than or equal to 0.5 mm, less than or equal to 0.4 mm, less than or equal to 0.3 mm, or less than or equal to 0.2 mm. Combinations of the above-referenced ranges are also possible (e.g., greater than or equal to 0.1 mm and less than or equal to 50 mm, greater than or equal to 0.1 mm and less than or equal to 25 mm, or greater than or equal to 0.5 mm and less than or equal to 10 mm). Other ranges are also possible. In embodiments in which more than one fiber web comprising fibrillated fibers is present, each fiber web comprising fibrillated fibers may independently comprise fibrillated fibers having an average length in one or more of the ranges described above.

Fibrillated fibers employed in the fiber webs described herein may have a suitable average diameter of the fibers. In some embodiments, a fiber web comprises fibrillated fibers having an average diameter of greater than or equal to 0.05 microns, greater than or equal to 0.075 microns, greater than or equal to 0.1 micron, greater than or equal to 0.2 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 40 microns, greater than or equal to 50 microns, or greater than or equal to 75 microns. In some embodiments, a fiber web comprises fibrillated fibers having an average diameter of less than or equal to 100 microns, less than or equal to 75 microns, less than or equal to 50 microns, less than or equal to 40 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.2 microns, less than or equal to 0.1 micron, or less than or equal to 0.075 microns. Combinations of the above-referenced ranges are also possible (e.g., greater than or equal to 0.05 micron and less than or equal to 100 microns, greater than or equal to 0.1 micron and less than or equal to 20 microns, or greater than or equal to 0.1 microns and less than or equal to 10 microns). Other ranges are also possible.

Some fiber webs may comprise fibrillated fibers in which the parent fibers have an average diameter in one or more of the ranges described above, some fiber webs may comprise fibrillated fibers in which the fibrils have an average diameter in one or more of the ranges described above, and some fiber webs may comprise fibrillated fibers in which both the parent fibers and the fibrillated fibers have average diameters in one or more of the non-overlapping ranges described above. In embodiments in which more than one fiber web comprising fibrillated fibers is present, each fiber web comprising fibrillated fibers may independently comprise fibrillated fibers for which the parent fibers and/or fibrils have an average diameter in one or more of the ranges described above.

When and if present, the fibrillated fibers may have any suitable Canadian Standard Freeness. The Canadian Standard Freeness of the fibrillated fibers may be selected to provide a desired pore size and/or air permeability for the fiber web and/or the separator. In general, lower values of Canadian Standard Freeness are correlated with smaller pore sizes and lower air permeabilities of the fiber web and/or separator comprising the fibrillated fibers, and higher values of Canadian Standard Freeness are correlated with larger pore sizes and higher air permeabilities of fiber web and/or separator comprising the fibrillated fibers. The Canadian Standard Freeness of the fibrillated fibers may be greater than or equal to 0 CSF, greater than or equal to 1 CSF, greater than or equal to 2 CSF, greater than or equal to 5 CSF, greater than or equal to 10 CSF, greater than or equal to 20 CSF, greater than or equal to 45 CSF, greater than or equal to 100 CSF, greater than or equal to 150 CSF, greater than or equal to 200 CSF, greater than or equal to 250 CSF, greater than or equal to 300 CSF, greater than or equal to 350 CSF, greater than or equal to 400 CSF, greater than or equal to 450 CSF, greater than or equal to 500 CSF, greater than or equal to 550 CSF, greater than or equal to 600 CSF, greater than or equal to 650 CSF, greater than or equal to 700 CSF, or greater than or equal to 750 CSF. The Canadian Standard Freeness of the fibrillated fibers may be less than or equal to 800 CSF, less than or equal to 750 CSF, less than or equal to 700 CSF, less than or equal to 650 CSF, less than or equal to 600 CSF, less than or equal to 550 CSF, less than or equal to 500 CSF, less than or equal to 450 CSF, less than or equal to 400 CSF, less than or equal to 350 CSF, less than or equal to 300 CSF, less than or equal to 250 CSF, less than or equal to 200 CSF, less than or equal to 150 CSF, less than or equal to 100 CSF, less than or equal to 45 CSF, less than or equal to 20 CSF, less than or equal to 10 CSF, less than or equal to 5 CSF, less than or equal to 2 CSF, or less than or equal to 1 CSF. Combinations of the above-referenced ranges also apply (e.g., greater than or equal to 0 CSF and less than or equal to 800 CSF, greater than or equal to 45 CSF and less than or equal to 800 CSF, greater than or equal to 300 CSF and less than or equal to 700 CSF, or greater than or equal to 550 CSF and less than or equal to 650 CSF). Other ranges are also possible. The Canadian Standard Freeness of the fibrillated fibers can be measured according to a Canadian Standard Freeness test, specified by TAPPI test method T-227-om-17 Freeness of pulp. The test can provide an average CSF value.

When and if present in a fiber web, fibrillated fibers may make up any suitable percentages thereof. Fibrillated fibers may make up greater than or equal to 0 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 55 wt %, greater than or equal to 60 wt %, greater than or equal to 65 wt %, greater than or equal to 70 wt %, greater than or equal to 75 wt %, greater than or equal to 80 wt %, greater than or equal to 85 wt %, greater than or equal to 90 wt %, or greater than or equal to 95 wt % of the fiber web. The fibrillated fibers may make up less than or equal to 100 wt %, less than or equal to 95 wt %, less than or equal to 90 wt %, less than or equal to 85 wt %, less than or equal to 80 wt %, less than or equal to 75 wt %, less than or equal to 70 wt %, less than or equal to 65 wt %, less than or equal to 60 wt %, less than or equal to 55 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, or less than or equal to 5 wt % of the fiber web. Combinations of the above-referenced ranges are also possible (e.g., greater than or equal to 0 wt % and less than or equal to 100 wt % of the fiber web, greater than or equal to 55 wt % and less than or equal to 95 wt % of the fiber web, or greater than or equal to 65 wt % and less than or equal to 85 wt % of the fiber web). Other ranges are also possible. In some embodiments, fibrillated fibers make up 100 wt % of the fiber web. In embodiments in which more than one fiber web is present, each fiber web may independently comprise fibrillated fibers in one or more of the amounts described above.

In some embodiments, a fiber web comprises multicomponent fibers. The multicomponent fibers may include more than one component in each fiber. In some embodiments, the multicomponent fibers are synthetic multicomponent fibers. Non-limiting examples of suitable components that may be present in multicomponent fibers include poly(olefin)s such as poly(ethylene), poly(propylene), and poly(butylene); polyesters and/or co-polyesters such as poly(ethylene terephthalate) and poly(butylene terephthalate); polyamides such as nylons and aramids; and halogenated polymers such as poly(tetrafluoroethylene). In embodiments in which more than one fiber web comprising multicomponent fibers is present, each fiber web comprising multicomponent fibers may independently comprise multicomponent fibers comprising one or more of the types of fibers described above.

When present, multicomponent fibers may have a variety of suitable structures. In some embodiments, the multicomponent fibers comprise bicomponent fibers (i.e., fibers including two components). The bicomponent fibers may have a variety of suitable structures. For instance, a fiber web may comprise one or more of the following types of bicomponent fibers: core/sheath fibers (e.g., concentric core/sheath fibers, non-concentric core-sheath fibers), split fibers, side-by-side fibers, and “island in the sea” fibers. When core-sheath bicomponent fibers are present, the sheath may have a lower melting temperature than the core. When heated, the sheath may melt prior to the core, binding other fibers within the fiber web together while the core remains solid. Non-limiting examples of suitable bicomponent fibers, in which the component with the lower melting temperature is listed first and the component with the higher melting temperature is listed second, include the following: poly(ethylene)/poly(ethylene terephthalate), poly(propylene)/poly(ethylene terephthalate), co-poly(ethylene terephthalate)/poly(ethylene terephthalate), poly(butylene terephthalate)/poly(ethylene terephthalate), co-polyamide/polyamide, and poly(ethylene)/poly(propylene). In embodiments in which more than one fiber web comprising multicomponent fibers is present, each fiber web comprising multicomponent fibers may independently comprise multicomponent fibers comprising one or more of the types of fibers described above.

In some embodiments, a fiber web comprises multicomponent fibers that are non-continuous. The multicomponent fibers in the fiber web may have an average fiber length of greater than or equal to 0.1 mm, greater than or equal to 0.2 mm, greater than or equal to 0.5 mm, greater than or equal to 1 mm, greater than or equal to 2 mm, greater than or equal to 5 mm, greater than or equal to 10 mm, greater than or equal to 15 mm, greater than or equal to 20 mm, greater than or equal to 25 mm, greater than or equal to 30 mm, greater than or equal to 38 mm, greater than or equal to 40 mm, greater than or equal to 45 mm, greater than or equal to 50 mm, greater than or equal to 55 mm, greater than or equal to 60 mm, greater than or equal to 65 mm, greater than or equal to 70 mm, greater than or equal to 76 mm, greater than or equal to 80 mm, greater than or equal to 85 mm, greater than or equal to 90 mm, greater than or equal to 100 mm, greater than or equal to 125 mm, greater than or equal to 150 mm, greater than or equal to 175 mm, greater than or equal to 200 mm, or greater than or equal to 250 mm. The multicomponent fibers in the fiber web may have an average fiber length of less than or equal to 300 mm, less than or equal to 250 mm, less than or equal to 200 mm, less than or equal to 175 mm, less than or equal to 150 mm, less than or equal to 125 mm, less than or equal to 100 mm, less than or equal to 90 mm, less than or equal to 85 mm, less than or equal to 80 mm, less than or equal to 76 mm, less than or equal to 70 mm, less than or equal to 65 mm, less than or equal to 60 mm, less than or equal to 55 mm, less than or equal to 50 mm, less than or equal to 45 mm, less than or equal to 40 mm, less than or equal to 38 mm, less than or equal to 30 mm, less than or equal to 25 mm, less than or equal to 20 mm, less than or equal to 15 mm, less than or equal to 10 mm, less than or equal to 5 mm, less than or equal to 2 mm, less than or equal to 1 mm, less than or equal to 0.5 mm, or less than or equal to 0.2 mm. Combinations of the above-referenced ranges are also possible (e.g., greater than or equal to 0.1 mm and less than or equal to 300 mm, greater than or equal to 2 mm and less than or equal to 100 mm, or greater than or equal to 38 mm and less than or equal to 76 mm). Other ranges are also possible. In embodiments in which more than one fiber web comprising multicomponent fibers is present, each fiber web comprising multicomponent fibers may independently comprise multicomponent fibers having an average length in one or more of the ranges described above.

Multicomponent fibers employed in the fiber webs described herein may have a suitable average diameter. In some embodiments, a fiber web comprises multicomponent fibers having an average diameter of greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, or greater than or equal to 40 microns. In some embodiments, a fiber web comprises multicomponent fibers having an average diameter of less than or equal to 50 microns, less than or equal to 40 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2 microns, less than or equal to 1 micron, less than or equal to 0.75 microns, less than or equal to 0.5 microns, or less than or equal to 0.2 microns. Combinations of the above-referenced ranges are also possible (e.g., greater than or equal to 0.1 micron and less than or equal to 20 microns, greater than or equal to 1 micron and less than or equal to 20 microns, or greater than or equal to 5 microns and less than or equal to 15 microns). Other ranges are also possible. In embodiments in which more than one fiber web comprising multicomponent fibers is present, each fiber web comprising multicomponent fibers may independently comprise multicomponent fibers having an average diameter in one or more of the ranges described above.

When and if present in a fiber web, multicomponent fibers may make up any suitable percentages thereof. Multicomponent fibers may make up greater than or equal to 0 wt %, greater than or equal to 5 wt %, greater than or equal to 10 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 60 wt %, greater than or equal to 70 wt %, greater than or equal to 80 wt %, or greater than or equal to 90 wt % of the fiber web. In some embodiments, multicomponent fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 10 wt %, or less than or equal to 5 wt % of the fiber web. Combinations of the above-referenced ranges are also possible (e.g., greater than or equal to 0 wt % and less than or equal to 100 wt % of the fiber web, greater than or equal to 5 wt % and less than or equal to 45 wt % of the fiber web, or greater than or equal to 15 wt % and less than or equal to 35 wt % of the fiber web). In some embodiments, multicomponent fibers make up 100 wt % of the fiber web. Other ranges are also possible. In embodiments in which more than one fiber web is present, each fiber web may independently comprise multicomponent fibers in one or more of the amounts described above.

In some embodiments, a fiber web comprises fibers that are crimped. As known to those of ordinary skill in the art, crimped fibers comprise one or more undulations and/or one or more waves that extend along at least a portion of the fiber as a whole (in other words, at least a portion of the fiber has a structure that, as a whole, is undulated and/or waved). The undulation(s) and/or wave(s) may comprise undulation(s) and/or wave(s) that are naturally occurring (e.g., undulation(s) and/or wave(s) that formed during fiber formation) and/or undulation(s) and/or wave(s) that form during chemical processing of the fiber. Crimped fibers typically have a more open structure than uncrimped fibers, and so may enhance the porosity of fiber webs in which they are positioned. The crimped fibers may be and/or comprise synthetic fibers, staple fibers, and/or non-continuous fibers, and so may have one or more of the properties described above with respect to these fiber types.

In some embodiments, a fiber web comprises glass fibers. The glass fibers may include microglass fibers and/or chopped strand glass fibers. By way of example, a fiber web may comprise microglass fibers which were produced by drawing a melt of glass from brushing tips into continuous fibers and then subjecting the continuous fibers to a flame blowing process and/or a rotary spinning process. In some embodiments, a fiber web may comprise microglass fibers formed by a remelting process. As another example, a fiber web may comprise chopped strand glass fibers which were produced by drawing a melt of glass from bushing tips into continuous fibers and then cutting the continuous fibers into short fibers. The chopped strand glass fibers may comprise chopped strand glass fibers for which alkali metal oxides (e.g., sodium oxides, magnesium oxides) make up a relatively low amount of the fibers. In some embodiments, chopped strand glass fibers may include relatively large amounts of calcium oxide and/or alumina. In embodiments in which more than one fiber web comprising glass fibers is present, each fiber web comprising glass fibers may independently comprise glass fibers comprising one or more of the types of fibers described above.

If and when present in the fiber web, the glass fibers may have a suitable average length. In some embodiments, the glass fibers have an average length of greater than or equal to 0.01 mm, greater than or equal to 0.02 mm, greater than or equal to 0.03 mm, greater than or equal to 0.04 mm, greater than or equal to 0.05 mm, greater than or equal to 0.075 mm, greater than or equal to 0.1 mm, greater than or equal to 0.2 mm, greater than or equal to 0.3 mm, greater than or equal to 0.4 mm, greater than or equal to 0.5 mm, greater than or equal to 0.75 mm, greater than or equal to 1 mm, greater than or equal to 2 mm, greater than or equal to 3 mm, greater than or equal to 4 mm, greater than or equal to 5 mm, greater than or equal to 7.5 mm, greater than or equal to 10 mm, greater than or equal to 20 mm, greater than or equal to 50 mm, greater than or equal to 100 mm, or greater than or equal to 200 mm. In some embodiments, the glass fibers have an average length of less than or equal to 300 mm, less than or equal to 200 mm, less than or equal to 100 mm, less than or equal to 50 mm, less than or equal to 20 mm, less than or equal to 10 mm, less than or equal to 7.5 mm, less than or equal to 5 mm, less than or equal to 4 mm, less than or equal to 3 mm, less than or equal to 2 mm, less than or equal to 1 mm, less than or equal to 0.75 mm, less than or equal to 0.5 mm, less than or equal to 0.4 mm, less than or equal to 0.3 mm, less than or equal to 0.2 mm, less than or equal to 0.1 mm, less than or equal to 0.075 mm, less than or equal to 0.05 mm, less than or equal to 0.04 mm, less than or equal to 0.03 mm, or less than or equal to 0.02 mm. Combinations of the above-referenced ranges are also possible (e.g., greater than or equal to 0.01 mm and less than or equal to 300 mm, greater than or equal to 0.1 mm and less than or equal to 2 mm, or greater than or equal to 0.2 mm and less than or equal to 1 mm). Other ranges are also possible. In embodiments in which more than one fiber web comprising glass fibers is present, each fiber web comprising glass fibers may independently comprise glass fibers having an average length in one or more of the ranges described above.

If and when present in a fiber web, the glass fibers may have a suitable average diameter. In some embodiments, the glass fibers have an average diameter of greater than or equal to 0.1 micron, greater than or equal to 0.2 microns, greater than or equal to 0.3 microns, greater than or equal to 0.4 microns, greater than or equal to 0.5 microns, greater than or equal to 0.6 microns, greater than or equal to 0.7 microns, greater than or equal to 0.8 microns, greater than or equal to 0.9 microns, greater than or equal to 1 micron, greater than or equal to 1.25 microns, greater than or equal to 1.5 microns, greater than or equal to 1.75 microns, greater than or equal to 2 microns, greater than or equal to 2.25 microns, greater than or equal to 2.5 microns, greater than or equal to 3 microns, greater than or equal to 3.5 microns, greater than or equal to 4 microns, greater than or equal to 5 microns, greater than or equal to 7.5 microns, greater than or equal to 10 microns, greater than or equal to 15 microns, greater than or equal to 20 microns, or greater than or equal to 30 microns. In some embodiments, the glass fibers have an average diameter of less than or equal to 40 microns, less than or equal to 30 microns, less than or equal to 20 microns, less than or equal to 15 microns, less than or equal to 10 microns, less than or equal to 7.5 microns, less than or equal to 5 microns, less than or equal to 4 microns, less than or equal to 3.5 microns, less than or equal to 3 microns, less than or equal to 2.5 microns, less than or equal to 2.25 microns, less than or equal to 2 microns, less than or equal to 1.75 microns, less than or equal to 1.5 microns, less than or equal to 1.25 microns, less than or equal to 1 micron, less than or equal to 0.9 microns, less than or equal to 0.8 microns, less than or equal to 0.7 microns, less than or equal to 0.6 microns, less than or equal to 0.5 microns, less than or equal to 0.4 microns, less than or equal to 0.3 microns, or less than or equal to 0.2 microns. Combinations of the above-referenced ranges are also possible (e.g., greater than or equal to 0.1 micron and less than or equal to 40 microns, greater than or equal to 0.4 microns and less than or equal to 20 microns, or greater than or equal to 0.8 microns and less than or equal to 2.5 microns). Other ranges are also possible. In embodiments in which more than one fiber web comprising glass fibers is present, each fiber web comprising glass fibers may independently comprise glass fibers having an average diameter in one or more of the ranges described above.

In some embodiments, if glass fibers are present in the fiber web, the glass fibers may make up a relatively small amount of the fiber web. For instance, glass fibers may make up less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2 wt %, or less than or equal to 1 wt % of the fiber web. In some embodiments, glass fibers make up greater than or equal to 0 wt %, greater than or equal to 1 wt %, greater than or equal to 2 wt %, greater than or equal to 3 wt %, greater than or equal to 4 wt %, greater than or equal to 5 wt %, greater than or equal to 7.5 wt %, greater than or equal to 10 wt %, greater than or equal to 12.5 wt %, greater than or equal to 15 wt %, or greater than or equal to 17.5 wt % of the fiber web. Combinations of the above-referenced ranges are also possible (e.g., greater than or equal to 0 wt % and less than or equal to 20 wt % of the fiber web, greater than or equal to 0 wt % and less than or equal to 10 wt % of the fiber web, or greater than or equal to 0 wt % and less than or equal to 5 wt % of the fiber web). In some embodiments, the fiber web includes 0 wt % glass fibers. Other ranges are also possible. In embodiments in which more than one fiber web is present, each fiber web may independently comprise glass fibers in one or more of the amounts described above.

In some embodiments, a fiber web comprises one or more further types of fibers in addition to those described above. For instance, a fiber web may comprise natural fibers (e.g., cellulose fibers, such as non-fibrillated cellulose fibers). When a fiber web comprises natural cellulose fibers, the natural cellulose fibers may be wood (e.g., cedar) fibers, such as softwood fibers and/or hardwood fibers.

Exemplary softwood fibers include fibers obtained from mercerized southern pine (“mercerized southern pine fibers or HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), and/or chemically treated mechanical pulps (“CTMP fibers”). For example, HPZ fibers can be obtained from Buckeye Technologies, Inc., Memphis, Tenn.; Robur Flash fibers can be obtained from Rottneros AB, Stockholm, Sweden; and Brunswick pine fibers can be obtained from Georgia-Pacific, Atlanta, Ga.

Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, Conn. (“Westvaco fibers”), and (6) Georgia-Pacific, Atlanta, Ga. (“Leaf River fibers”).

In some embodiments, a fiber web comprises one or more types of particles. For instance, a fiber web may comprise rubber particles (i.e., particles comprising a rubber), sulfate salt particles (i.e., particles comprising a sulfate salt), and/or other types of inorganic particles (i.e. particles comprising an inorganic compound other than a sulfate salt).

Without wishing to be bound by any particular theory, it is believed that the inclusion of rubber particles in a fiber web may advantageously improve performance of batteries in which the battery separator is positioned because the rubber may scavenge certain heavy metals (e.g., antimony) present in the battery that are believed to reduce battery performance. It is believed that rubber particles from a fiber web may at least partially dissolve in the electrolyte upon exposure thereto, and, once in the electrolyte, may bind with heavy metals therein, thereby removing them from the electrolyte. As heavy metals present in the electrolyte are believed to undesirably deposit on battery plates (in some cases irreversibly) and/or increase water consumption, it is believed that rubber that prevents such phenomena by scavenging heavy metal in the electrolyte may enhance battery operation.

A variety of suitable types of rubber particles may be employed in the fiber webs described herein. In some embodiments, a fiber web comprises rubber particles comprising natural rubber. By way of example, a fiber web may comprise rubber particles comprising smoked sheet rubber, pale crepe rubber, blanket crepe rubber, brown crepe rubber, amber crepe rubber, flat bark crepe rubber, Hevea brasiliensis rubber, and/or a latex of natural rubber. In some embodiments, a fiber web comprises rubber particles comprising synthetic rubber. For instance, a fiber web may comprise rubber particles comprising styrene-butadiene rubber, acrylonitrile butadiene rubber, poly(butyldiene) rubber, poly(isoprene) rubber, nitrile rubber, butyl rubber, ethylene-propylene rubber, silicone rubber, poly(sulfide) rubber, and/or poly(acrylate) rubber. Rubber particles may comprise cured rubber and/or uncured rubber. In embodiments in which more than one fiber web comprising rubber particles is present, each fiber web comprising rubber particles may independently comprise rubber particles comprising one or more of the types of rubber described above.

A fiber web may comprise rubber particles having a suitable average diameter. In some embodiments, a fiber web comprises rubber particles having an average diameter of greater than or equal to 1 micron, greater than or equal to 2 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 40 microns, greater than or equal to 50 microns, or greater than or equal to 75 microns. In some embodiments, a fiber web comprises rubber particles having an average diameter of less than or equal to 100 microns, less than or equal to 75 microns, less than or equal to 50 microns, less than or equal to 40 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, or less than or equal to 2 microns. Combinations of the above-referenced ranges are also possible (e.g., greater than or equal to 1 micron and less than or equal to 100 microns, greater than or equal to 2 microns and less than or equal to 40 microns, or greater than or equal to 3 microns and less than or equal to 20 microns). Other ranges are also possible. In embodiments in which more than one fiber web comprising rubber particles is present, each fiber web comprising rubber particles may independently comprise rubber particles having an average diameter in one or more of the ranges described above.

When present in a fiber web, rubber particles may make up a suitable portion thereof. In some embodiments, rubber particles make up greater than or equal to 0 wt %, greater than or equal to 1 wt %, greater than or equal to 2 wt %, greater than or equal to 3 wt %, greater than or equal to 4 wt %, greater than or equal to 5 wt %, greater than or equal to 7.5 wt %, greater than or equal to 10 wt %, greater than or equal to 12.5 wt %, greater than or equal to 15 wt %, or greater than or equal to 17.5 wt % of the fiber web. In some embodiments, rubber particles make up less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2 wt %, or less than or equal to 1 wt % of the fiber web. Combinations of the above-referenced ranges are also possible (e.g., greater than or equal to 0 wt % and less than or equal to 20 wt % of the fiber web, greater than or equal to 0 wt % and less than or equal to 10 wt % of the fiber web, or greater than or equal to 0 wt % and less than or equal to 5 wt % of the fiber web). In some embodiments, the fiber web includes 0 wt % rubber particles. Other ranges are also possible. In embodiments in which more than one fiber web is present, each fiber web may independently comprise rubber particles in one or more of the amounts described above.

Without wishing to be bound by any particular theory, it is believed that the inclusion of sulfate salt particles in a fiber web may advantageously reduce the tendency of the batteries in which the battery separator is positioned to form shorts. It is believed that shorts may form when dissolved lead ions precipitate from the electrolyte onto one or more portions of the battery to produce lead deposits that together form a conductive, short circuit, pathway through the battery. It is also believed that sulfate salts may inhibit dissolution of lead sulfate into the electrolyte due to the common ion effect, thereby reducing the total amount of lead ions in the electrolyte. It is believed that reduced amounts of lead ions present in the electrolyte reduce the tendency of the lead ions therein to precipitate therefrom, and, accordingly, that lead sulfate particles thus inhibit the production of shorts.

A variety of suitable types of sulfate salt particles may be employed in the fiber webs described herein. Non-limiting examples of suitable types of sulfate salts that may be included in sulfate salt particles include alkali metal sulfate salts (e.g., sodium sulfate, potassium sulfate), alkaline earth metal sulfate salts (e.g., magnesium sulfate, calcium sulfate), aluminum sulfate, and transition metal sulfate salts (e.g., cobalt sulfate, zinc sulfate). In embodiments in which more than one fiber web comprising sulfate salt particles is present, each fiber web comprising sulfate salt particles may independently comprise sulfate salt particles comprising one or more of the sulfate salts described above.

A fiber web may comprise sulfate salt particles having a suitable average diameter. In some embodiments, a fiber web comprises sulfate salt particles having an average diameter of greater than or equal to 0.01 micron, greater than or equal to 0.02 microns, greater than or equal to 0.05 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 30 microns, greater than or equal to 40 microns, greater than or equal to 50 microns, or greater than or equal to 75 microns. In some embodiments, a fiber web comprises sulfate salt particles having an average diameter of less than or equal to 100 microns, less than or equal to 75 microns, less than or equal to 50 microns, less than or equal to 40 microns, less than or equal to 30 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, less than or equal to 2 microns, less than or equal to 1 micron, less than or equal to 0.75 microns, less than or equal to 0.5 microns, less than or equal to 0.2 microns, less than or equal to 0.1 micron, less than or equal to 0.05 microns, or less than or equal to 0.02 microns. Combinations of the above-referenced ranges are also possible (e.g., greater than or equal to 0.01 micron and less than or equal to 100 microns, greater than or equal to 1 micron and less than or equal to 50 microns, or greater than or equal to 3 microns and less than or equal to 20 microns). Other ranges are also possible. In embodiments in which more than one fiber web comprising sulfate salt particles is present, each fiber web comprising sulfate salt particles may independently comprise sulfate salt particles having an average diameter in one or more of the ranges described above.

If and when present in a fiber web, sulfate salt particles may make up a suitable portion thereof. In some embodiments, sulfate salt particles make up greater than or equal to 0 wt %, greater than or equal to 1 wt %, greater than or equal to 2 wt %, greater than or equal to 3 wt %, greater than or equal to 4 wt %, greater than or equal to 5 wt %, greater than or equal to 7.5 wt %, greater than or equal to 10 wt %, greater than or equal to 12.5 wt %, greater than or equal to 15 wt %, or greater than or equal to 17.5 wt % of the fiber web. In some embodiments, sulfate salt particles make up less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2 wt %, or less than or equal to 1 wt % of the fiber web. Combinations of the above-referenced ranges are also possible (e.g., greater than or equal to 0 wt % and less than or equal to 20 wt % of the fiber web, greater than or equal to 0 wt % and less than or equal to 10 wt % of the fiber web, or greater than or equal to 0 wt % and less than or equal to 5 wt % of the fiber web). In some embodiments, the fiber web includes 0 wt % sulfate salt particles. Other ranges are also possible. In embodiments in which more than one fiber web is present, each fiber web may independently comprise sulfate salt particles in one or more of the amounts described above.

The inclusion of inorganic particles other than sulfate salts in the fiber web may provide the battery separator with a number of advantages. For instance, such inorganic particles may reduce the pore size of the fiber web without significantly altering the porosity of the fiber web, increase the wicking and/or wettability of the fiber web, enhance electrolyte absorption by the fiber web, and/or scavenge harmful contaminants such as heavy metal ions (which may provide some or all of the advantages described above with respect to rubber particles). By way of example, in some embodiments inorganic particles may comprise very fine pores that create enhanced capillary forces which increase electrolyte absorption and/or contaminant trapping. In some embodiments, a fiber web comprises inorganic particles that coat the fibers therein and serve to reduce the pore size and/or the variation in pore size thereof.

A variety of suitable inorganic particles may be included in the fiber webs described herein. For instance, a fiber web may comprise silica particles (e.g., fumed silica particles, natural and/or mined silica particles, fused silica particles, precipitated silica particles, agglomerated silica particles), clay particles, talc particles, particles comprising diatoms (e.g., diatomaceous earth), zeolite particles, titania particles, and/or ash particles (e.g., rice husk ash particles). In embodiments in which more than one fiber web comprising inorganic particles is present, each fiber web comprising inorganic particles may independently comprise inorganic particles comprising one or more of the types of inorganic materials described above.

A fiber web may comprise inorganic particles having a suitable average diameter. In some embodiments, a fiber web comprises inorganic particles having an average diameter of greater than or equal to 1 micron, greater than or equal to 2 microns, greater than or equal to 3 microns, greater than or equal to 4 microns, greater than or equal to 5 microns, greater than or equal to 7.5 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 40 microns, greater than or equal to 50 microns, or greater than or equal to 75 microns. In some embodiments, a fiber web comprises inorganic particles having an average diameter of less than or equal to 100 microns, less than or equal to 75 microns, less than or equal to 50 microns, less than or equal to 40 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 7.5 microns, less than or equal to 5 microns, less than or equal to 4 microns, less than or equal to 3 microns, or less than or equal to 2 microns. Combinations of the above-referenced ranges are also possible (e.g., greater than or equal to 1 micron and less than or equal to 100 microns, greater than or equal to 2 microns and less than or equal to 20 microns, or greater than or equal to 3 microns and less than or equal to 10 microns). Other ranges are also possible. In embodiments in which more than one fiber web comprising inorganic particles is present, each fiber web comprising inorganic particles may independently comprise inorganic particles having an average diameter in one or more of the ranges described above.

A fiber web may comprise inorganic particles having a suitable average specific surface area. In some embodiments, a fiber web comprises inorganic particles having an average specific surface area of greater than or equal to 10 m²/g, greater than or equal to 20 m²/g, greater than or equal to 30 m²/g, greater than or equal to 40 m²/g, greater than or equal to 50 m²/g, greater than or equal to 75 m²/g, greater than or equal to 100 m²/g, greater than or equal to 150 m²/g, greater than or equal to 200 m²/g, greater than or equal to 250 m²/g, greater than or equal to 300 m²/g, greater than or equal to 350 m²/g, greater than or equal to 400 m²/g, greater than or equal to 450 m²/g, greater than or equal to 500 m²/g, greater than or equal to 600 m²/g, greater than or equal to 800 m²/g, greater than or equal to 1000 m²/g, or greater than or equal to 1500 m²/g. In some embodiments, a fiber web comprises inorganic particles having an average specific surface area of less than or equal to 2000 m²/g, less than or equal to 1500 m²/g, less than or equal to 1000 m²/g, less than or equal to 800 m²/g, less than or equal to 600 m²/g, less than or equal to 500 m²/g, less than or equal to 450 m²/g, less than or equal to 400 m²/g, less than or equal to 350 m²/g, less than or equal to 300 m²/g, less than or equal to 250 m²/g, less than or equal to 200 m²/g, less than or equal to 150 m²/g, less than or equal to 100 m²/g, less than or equal to 75 m²/g, less than or equal to 50 m²/g, less than or equal to 40 m²/g, less than or equal to 30 m²/g, or less than or equal to 20 m²/g. Combinations of the above-referenced ranges are also possible (e.g., greater than or equal to 10 m²/g and less than or equal to 2000 m²/g, greater than or equal to 50 m²/g and less than or equal to 1000 m²/g, or greater than or equal to 400 m²/g and less than or equal to 600 m²/g). Other ranges are also possible. In embodiments in which more than one fiber web comprising inorganic particles is present, each fiber web comprising inorganic particles may independently comprise inorganic particles having an average specific surface area in one or more of the ranges described above.

The specific surface area of inorganic particles may be determined in accordance with section 10 of Battery Council International Standard BCIS-03A (2009), “Recommended Battery Materials Specifications Valve Regulated Recombinant Batteries”, section 10 being “Standard Test Method for Surface Area of Recombinant Battery Separator Mat”. Following this technique, the specific surface area is measured via adsorption analysis using a BET surface analyzer (e.g., Micromeritics Gemini III 2375 Surface Area Analyzer) with nitrogen gas; the sample amount is between 0.5 and 0.6 grams in a 3/4″ tube; and, the sample is allowed to degas at 100° C. for a minimum of 3 hours.

If and when present in a fiber web, inorganic particles may make up a suitable portion thereof. In some embodiments, inorganic particles make up greater than or equal to 0 wt %, greater than or equal to 1 wt %, greater than or equal to 2 wt %, greater than or equal to 3 wt %, greater than or equal to 4 wt %, greater than or equal to 5 wt %, greater than or equal to 7.5 wt %, greater than or equal to 10 wt %, greater than or equal to 12.5 wt %, greater than or equal to 15 wt %, or greater than or equal to 17.5 wt % of the fiber web. In some embodiments, inorganic particles make up less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2 wt %, or less than or equal to 1 wt % of the fiber web. Combinations of the above-referenced ranges are also possible (e.g., greater than or equal to 0 wt % and less than or equal to 20 wt % of the fiber web, greater than or equal to 0 wt % and less than or equal to 10 wt % of the fiber web, or greater than or equal to 0 wt % and less than or equal to 5 wt % of the fiber web). In some embodiments, the fiber web includes 0 wt % inorganic particles. Other ranges are also possible. In embodiments in which more than one fiber web is present, each fiber web may independently comprise inorganic particles in one or more of the amounts described above.

In some embodiments, a fiber web further comprises a resin (e.g., a non-fibrous resin). The resin may comprise a polymer, such as styrene acrylate, styrene butyl acrylate, styrene butadiene, poly(methyl methacrylate), a copolymer of styrene and methyl methacrylate, a phenolic resin, acrylonitrile rubber, poly(ethylene), and/or poly(urethane).

If and when present in a fiber web, resin may make up a relatively small amount thereof. For instance, resin (e.g., a non-fibrous resin) may make up less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, less than or equal to 4 wt %, less than or equal to 3 wt %, less than or equal to 2 wt %, or less than or equal to 1 wt % of the fiber web. In some embodiments, resin (e.g., a non-fibrous resin) makes up greater than or equal to 0 wt %, greater than or equal to 1 wt %, greater than or equal to 2 wt %, greater than or equal to 3 wt %, greater than or equal to 4 wt %, greater than or equal to 5 wt %, greater than or equal to 7.5 wt %, greater than or equal to 10 wt %, greater than or equal to 12.5 wt %, greater than or equal to 15 wt %, or greater than or equal to 17.5 wt % of the fiber web. Combinations of the above-referenced ranges are also possible (e.g., greater than or equal to 0 wt % and less than or equal to 20 wt % of the fiber web, greater than or equal to 0 wt % and less than or equal to 10 wt % of the fiber web, or greater than or equal to 0 wt % and less than or equal to 5 wt % of the fiber web). In some embodiments, the fiber web includes 0 wt % resin (e.g., non-fibrous resin). Other ranges are also possible. In embodiments in which more than one fiber web is present, each fiber web may independently comprise resin in one or more of the amounts described above.

The fiber webs described herein may have a relatively high porosity. In some embodiments, a fiber web has a porosity of greater than or equal to 50% greater than or equal to 55%, greater than or equal to 60%, greater than or equal to 65%, greater than or equal to 70%, greater than or equal to 75%, greater than or equal to 80%, greater than or equal to 85%, greater than or equal to 90%, or greater than or equal to 95%. In some embodiments, a fiber web has a porosity of less than or equal to 99%, less than or equal to 95%, less than or equal to 90%, less than or equal to 85%, less than or equal to 80%, less than or equal to 75%, less than or equal to 70%, less than or equal to 65%, less than or equal to 60%, or less than or equal to 55%. Combinations of the above-referenced ranges are also possible (e.g., greater than or equal to 50% and less than or equal to 99%, greater than or equal to 60% and less than or equal to 90%, or greater than or equal to 70% and less than or equal to 80%). Other ranges are also possible. In embodiments in which more than one fiber web is present, each fiber web may independently have a porosity in one or more of the ranges described above.

The porosity of a fiber web is equivalent to 100%−[solidity of the fiber web]. The solidity of a fiber web is equivalent to the percentage of the interior of the fiber web occupied by solid material. One non-limiting way of determining solidity of a fiber web is described in this paragraph, but other methods are also possible. The method described in this paragraph includes determining the basis weight and thickness of the fiber web and then applying the following formula: solidity=[basis weight of the fiber web/(density of the components forming the fiber web*thickness of the fiber web)]*100%. The density of the components forming the fiber web is equivalent to the average density of the material or material(s) forming the components of the fiber web (e.g., fibers, particles, resin), which is typically specified by the manufacturer of each material. The average density of the materials forming the components of the fiber web may be determined by: (1) determining the total volume of all of the components in the fiber web; and (2) dividing the total mass of all of the components in the fiber web by the total volume of all of the components in the fiber web. If the mass and density of each component of the fiber web are known, the volume of all the components in the fiber web may be determined by: (1) for each type of component, dividing the total mass of the component in the fiber web by the density of the component; and (2) summing the volumes of each component. If the mass and density of each component of the fiber web are not known, the volume of all the components in the fiber web may be determined in accordance with Archimedes' principle.

The fiber webs described herein may have a suitable mean flow pore size. In some embodiments, a fiber web has a mean flow pore size of greater than or equal to 0.01 micron, greater than or equal to 0.02 microns, greater than or equal to 0.05 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, or greater than or equal to 40 microns. In some embodiments, a fiber web has a mean flow pore size of less than or equal to 50 microns, less than or equal to 40 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 8 microns, less than or equal to 7 microns, less than or equal to 6 microns, less than or equal to 5 microns, less than or equal to 4 microns, less than or equal to 3 microns, less than or equal to 2 microns, less than or equal to 1 micron, less than or equal to 0.75 microns, less than or equal to 0.5 microns, less than or equal to 0.2 microns, less than or equal to 0.1 micron, less than or equal to 0.05 microns, or less than or equal to 0.02 microns. Combinations of the above-referenced ranges are also possible (e.g., greater than or equal to 0.01 micron and less than or equal to 50 microns, greater than or equal to 1 micron and less than or equal to 15 microns, or greater than or equal to 3 microns and less than or equal to 7 microns). Other ranges are also possible. In embodiments in which more than one fiber web is present, each fiber web may independently have a mean flow pore size in one or more of the ranges described above. The mean flow pore size of a fiber web may be determined in accordance with ASTM F316 (2003).

The fiber webs described herein may have a suitable maximum pore size. In some embodiments, a fiber web has a maximum pore size of greater than or equal to 0.01 micron, greater than or equal to 0.02 microns, greater than or equal to 0.05 microns, greater than or equal to 0.1 micron, greater than or equal to 0.2 microns, greater than or equal to 0.5 microns, greater than or equal to 0.75 microns, greater than or equal to 1 micron, greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 25 microns, greater than or equal to 30 microns, greater than or equal to 40 microns, or greater than or equal to 50 microns. In some embodiments, a fiber web has a maximum pore size of less than or equal to 70 microns, less than or equal to 50 microns, less than or equal to 40 microns, less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 8 microns, less than or equal to 7 microns, less than or equal to 6 microns, less than or equal to 5 microns, less than or equal to 4 microns, less than or equal to 3 microns, less than or equal to 2 microns, less than or equal to 1 micron, less than or equal to 0.75 microns, less than or equal to 0.5 microns, less than or equal to 0.2 microns, less than or equal to 0.1 micron, less than or equal to 0.05 microns, or less than or equal to 0.02 microns. Combinations of the above-referenced ranges are also possible (e.g., greater than or equal to 0.01 micron and less than or equal to 70 microns, greater than or equal to 8 microns and less than or equal to 25 microns, or greater than or equal to 10 microns and less than or equal to 15 microns). Other ranges are also possible. In embodiments in which more than one fiber web is present, each fiber web may independently have a maximum pore size in one or more of the ranges described above. The maximum pore size of a fiber web may be determined in accordance with ASTM F316 (2003).

The fiber webs described herein may have a suitable basis weight. In some embodiments, a fiber web has a basis weight of greater than or equal to 2 g/m², greater than or equal to 5 g/m², greater than or equal to 10 g/m², greater than or equal to 20 g/m², greater than or equal to 30 g/m², greater than or equal to 40 g/m², greater than or equal to 50 g/m², greater than or equal to 60 g/m², greater than or equal to 80 g/m², greater than or equal to 100 g/m², greater than or equal to 120 g/m², greater than or equal to 150 g/m², greater than or equal to 200 g/m², greater than or equal to 250 g/m², greater than or equal to 300 g/m², or greater than or equal to 400 g/m². In some embodiments, a fiber web has a basis weight of less than or equal to 500 g/m², less than or equal to 400 g/m², less than or equal to 300 g/m², less than or equal to 250 g/m², less than or equal to 200 g/m², less than or equal to 150 g/m², less than or equal to 120 g/m², less than or equal to 100 g/m², less than or equal to 80 g/m², less than or equal to 60 g/m², less than or equal to 50 g/m², less than or equal to 40 g/m², less than or equal to 30 g/m², less than or equal to 20 g/m², less than or equal to 10 g/m², or less than or equal to 5 g/m². Combinations of the above-referenced ranges are also possible (e.g., greater than or equal to 2 g/m² and less than or equal to 500 g/m², greater than or equal to 40 g/m² and less than or equal to 150 g/m², greater than or equal to 60 g/m² and less than or equal to 120 g/m²). Other ranges are also possible. In embodiments in which more than one fiber web is present, each fiber web may independently have a basis weight in one or more of the ranges described above. The basis weight of a fiber web may be determined in accordance with ISO 536:2012.

The fiber webs described herein may have a suitable thickness. In some embodiments, a fiber web has a thickness of greater than or equal to 0.01 mm, greater than or equal to 0.02 mm, greater than or equal to 0.05 mm, greater than or equal to 0.075 mm, greater than or equal to 0.1 mm, greater than or equal to 0.2 mm, greater than or equal to 0.3 mm, greater than or equal to 0.4 mm, greater than or equal to 0.5 mm, greater than or equal to 0.6 mm, greater than or equal to 0.7 mm, greater than or equal to 0.8 mm, greater than or equal to 1 mm, greater than or equal to 2 mm, greater than or equal to 3 mm, or greater than or equal to 4 mm. In some embodiments, a fiber web has a thickness of less than or equal to 5 mm, less than or equal to 4 mm, less than or equal to 3 mm, less than or equal to 2 mm, less than or equal to 1 mm, less than or equal to 0.8 mm, less than or equal to 0.7 mm, less than or equal to 0.6 mm, less than or equal to 0.5 mm, less than or equal to 0.4 mm, less than or equal to 0.3 mm, less than or equal to 0.2 mm, less than or equal to 0.1 mm, less than or equal to 0.075 mm, less than or equal to 0.05 mm, or less than or equal to 0.02 mm. Combinations of the above-referenced ranges are also possible (e.g., greater than or equal to 0.01 mm and less than or equal to 5 mm, greater than or equal to 0.1 mm and less than or equal to 1 mm, or greater than or equal to 0.2 mm and less than or equal to 0.6 mm). Other ranges are also possible. In embodiments in which more than one fiber web is present, each fiber web may independently have a thickness in one or more of the ranges described above. The thickness of a fiber web may be determined in accordance with CIS-03A, Sept-09, Method 10 under 10 kPa applied pressure.

The fiber webs described herein may have a suitable specific surface area. In some embodiments, a fiber web has a specific surface area of greater than or equal to 0.01 m²/g, greater than or equal to 0.02 m²/g, greater than or equal to 0.03 m²/g, greater than or equal to 0.04 m²/g, greater than or equal to 0.05 m²/g, greater than or equal to 0.06 m²/g, greater than or equal to 0.08 m²/g, greater than or equal to 0.1 m²/g, greater than or equal to 0.2 m²/g, greater than or equal to 0.3 m²/g, greater than or equal to 0.4 m²/g, greater than or equal to 0.5 m²/g, greater than or equal to 0.75 m²/g, greater than or equal to 1 m²/g, greater than or equal to 2 m²/g, greater than or equal to 5 m²/g, greater than or equal to 10 m²/g, greater than or equal to 20 m²/g, greater than or equal to 50 m²/g, greater than or equal to 100 m²/g, or greater than or equal to 200 m²/g. In some embodiments, a fiber web has a specific surface area of less than or equal to 400 m²/g, less than or equal to 200 m²/g, less than or equal to 100 m²/g, less than or equal to 50 m²/g, less than or equal to 20 m²/g, less than or equal to 10 m²/g, less than or equal to 5 m²/g, less than or equal to 2 m²/g, less than or equal to 1 m²/g, less than or equal to 0.75 m²/g, less than or equal to 0.5 m²/g, less than or equal to 0.4 m²/g, less than or equal to 0.3 m²/g, less than or equal to 0.2 m²/g, less than or equal to 0.1 m²/g, less than or equal to 0.08 m²/g, less than or equal to 0.06 m²/g, less than or equal to 0.05 m²/g, less than or equal to 0.04 m²/g, less than or equal to 0.03 m²/g, or less than or equal to 0.02 m²/g. Combinations of the above-referenced ranges are also possible (e.g., greater than or equal to 0.01 m²/g and less than or equal to 400 m²/g, greater than or equal to 0.04 m²/g and less than or equal to 0.5 m²/g, or greater than or equal to 0.1 m²/g and less than or equal to 0.3 m²/g). Other ranges are also possible. In embodiments in which more than one fiber web is present, each fiber web may independently have a specific surface area in one or more of the ranges described above.

The specific surface area of a fiber web may be determined in accordance with section 10 of Battery Council International Standard BCIS-03A (2009), “Recommended Battery Materials Specifications Valve Regulated Recombinant Batteries”, section 10 being “Standard Test Method for Surface Area of Recombinant Battery Separator Mat”. Following this technique, the specific surface area is measured via adsorption analysis using a BET surface analyzer (e.g., Micromeritics Gemini III 2375 Surface Area Analyzer) with nitrogen gas; the sample amount is between 0.5 and 0.6 grams in a ¾″ tube; and, the sample is allowed to degas at 100° C. for a minimum of 3 hours.

The fiber webs described herein may have a suitable air permeability. In some embodiments, a fiber web has an air permeability of greater than or equal to 0 CFM, greater than or equal to 0.1 CFM, greater than or equal to 0.2 CFM, greater than or equal to 0.3 CFM, greater than or equal to 0.4 CFM, greater than or equal to 0.5 CFM, greater than or equal to 0.75 CFM, greater than or equal to 1 CFM, greater than or equal to 2 CFM, greater than or equal to 3 CFM, greater than or equal to 4 CFM, greater than or equal to 5 CFM, greater than or equal to 7.5 CFM, greater than or equal to 10 CFM, greater than or equal to 20 CFM, or greater than or equal to 30 CFM. In some embodiments, a fiber web has an air permeability of less than or equal to 50 CFM, less than or equal to 30 CFM, less than or equal to 20 CFM, less than or equal to 10 CFM, less than or equal to 7.5 CFM, less than or equal to 5 CFM, less than or equal to 4 CFM, less than or equal to 3 CFM, less than or equal to 2 CFM, less than or equal to 1 CFM, less than or equal to 0.75 CFM, less than or equal to 0.5 CFM, less than or equal to 0.4 CFM, less than or equal to 0.3 CFM, less than or equal to 0.2 CFM, or less than or equal to 0.1 CFM. Combinations of the above-referenced ranges are also possible (e.g., greater than or equal to 0 CFM and less than or equal to 50 CFM, greater than or equal to 0.1 CFM and less than or equal to 5 CFM, or greater than or equal to 0.5 CFM and less than or equal to 3 CFM). Other ranges are also possible. In embodiments in which more than one fiber web is present, each fiber web may independently have an air permeability in one or more of the ranges described above. The air permeability of a fiber web may be determined in accordance with ASTM Test Standard D737-04 (2016) at a pressure of 125 Pa.

The fiber webs described herein may have a suitable water contact angle. In some embodiments, a fiber web has a water contact angle of greater than or equal to 0°, greater than or equal to 1°, greater than or equal to 2°, greater than or equal to 5°, greater than or equal to 10°, greater than or equal to 20°, greater than or equal to 40°, greater than or equal to 60°, greater than or equal to 80°, greater than or equal to 90°, greater than or equal to 100°, or greater than or equal to 120°. In some embodiments, a fiber web has a water contact angle of less than or equal to 150°, less than or equal to 120°, less than or equal to 100°, less than or equal to 90°, less than or equal to 80°, less than or equal to 60°, less than or equal to 40°, less than or equal to 20°, less than or equal to 10°, less than or equal to 5°, less than or equal to 2°, or less than or equal to 1°. Combinations of the above-referenced ranges are also possible (e.g., greater than or equal to 0° and less than or equal to 150°, greater than or equal to 0° and less than or equal to 120°, greater than or equal to 0° and less than or equal to 90°, or greater than or equal to 0° and less than or equal to)80°. Other ranges are also possible. In embodiments in which more than one fiber web is present, each fiber web may independently have a water contact angle in one or more of the ranges described above. The water contact angle of a fiber web may be determined in accordance with ASTM D5946 (2009). In some embodiments, a fiber web has a water contact angle in one or more of the ranges described above and has not undergone a surface treatment to increase its hydrophilicity or hydrophobicity. In other words, some fiber webs may have contact angles in one or more of the ranges described above and the fiber web and fibers therein may have unmodified surfaces.

In some embodiments, a fiber web described herein has a machine direction tensile strength that is relatively high. For instance, a fiber web may have a machine direction tensile strength of greater than or equal to 2 lbs/inch, greater than or equal to 5 lbs/inch, greater than or equal to 7.5 lbs/inch, greater than or equal to 10 lbs/inch, greater than or equal to 12.5 lbs/inch, greater than or equal to 15 lbs/inch, greater than or equal to 17.5 lbs/inch, greater than or equal to 20 lbs/inch, greater than or equal to 30 lbs/inch, greater than or equal to 50 lbs/inch, or greater than or equal to 75 lbs/inch. A fiber web may have a machine direction tensile strength of less than or equal to 100 lbs/inch, less than or equal to 75 lbs/inch, less than or equal to 50 lbs/inch, less than or equal to 30 lbs/inch, less than or equal to 20 lbs/inch, less than or equal to 17.5 lbs/inch, less than or equal to 15 lbs/inch, less than or equal to 12.5 lbs/inch, less than or equal to 10 lbs/inch, less than or equal to 7.5 lbs/inch, or less than or equal to 5 lbs/inch. Combinations of the above-referenced ranges are also possible (e.g., greater than or equal to 2 lbs/inch and less than or equal to 100 lbs/inch, greater than or equal to 10 lbs/inch and less than or equal to 100 lbs/inch, or greater than or equal to 15 lbs/inch and less than or equal to 100 lbs/inch). Other ranges are also possible. In embodiments in which more than one fiber web is present, each fiber web may independently have a machine direction tensile strength in one or more of the ranges described above. The machine direction tensile strength of a fiber web may be determined in accordance with BCIS 03B (2018).

In some embodiments, a fiber web described herein has a relatively high elongation at break. For instance, a fiber web may have an elongation at break of greater than or equal to 0%, greater than or equal to 1%, greater than or equal to 2%, greater than or equal to 5%, greater than or equal to 7.5%, greater than or equal to 10%, greater than or equal to 15%, greater than or equal to 20%, greater than or equal to 25%, greater than or equal to 30%, greater than or equal to 40%, greater than or equal to 50%, greater than or equal to 75%, greater than or equal to 100%, greater than or equal to 150%, greater than or equal to 200%, greater than or equal to 300%, or greater than or equal to 400%. A fiber web may have an elongation at break of less than or equal to 500%, less than or equal to 400%, less than or equal to 300%, less than or equal to 200%, less than or equal to 150%, less than or equal to 100%, less than or equal to 75%, less than or equal to 50%, less than or equal to 40%, less than or equal to 30%, less than or equal to 25%, less than or equal to 20%, less than or equal to 15%, less than or equal to 10%, less than or equal to 7.5%, less than or equal to 5%, less than or equal to 2%, or less than or equal to 1%. Combinations of the above-referenced ranges are also possible (e.g., greater than or equal to 0% and less than or equal to 500%, or greater than or equal to 10% and less than or equal to 100%). Other ranges are also possible. In embodiments in which more than one fiber web is present, each fiber web may independently have an elongation at break in one or more of the ranges described above. The elongation at break of a fiber web may be determined in accordance with BCIS 03B (2018).

In some embodiments, a fiber web described herein has a relatively high puncture strength. For instance, a fiber web may have a puncture strength of greater than or equal to 2 N, greater than or equal to 4 N, greater than or equal to 6 N, greater than or equal to 8 N, greater than or equal to 10 N, greater than or equal to 12 N, greater than or equal to 14 N, greater than or equal to 16 N, greater than or equal to 18 N, greater than or equal to 20 N, greater than or equal to 22.5 N, greater than or equal to 25 N, greater than or equal to 27.5 N, greater than or equal to 30 N, greater than or equal to 35 N, greater than or equal to 42 N, greater than or equal to 50 N, or greater than or equal to 75 N. A fiber web may have a puncture strength of less than or equal to 100 N, less than or equal to 75 N, less than or equal to 50 N, less than or equal to 42 N, less than or equal to 35 N, less than or equal to 30 N, less than or equal to 27.5 N, less than or equal to 25 N, less than or equal to 22.5 N, less than or equal to 20 N, less than or equal to 18 N, less than or equal to 16 N, less than or equal to 14 N, less than or equal to 12 N, less than or equal to 10 N, less than or equal to 8 N, less than or equal to 6 N, or less than or equal to 4 N. Combinations of the above-referenced ranges are also possible (e.g., greater than or equal to 2 N and less than or equal to 100 N, greater than or equal to 12 N and less than or equal to 42 N, or greater than or equal to 16 N and less than or equal to 25 N). Other ranges are also possible. In embodiments in which more than one fiber web is present, each fiber web may independently have a puncture strength in one or more of the ranges described above. The puncture strength of a fiber web may be determined in accordance with BCIS 03B (2018).

The fiber webs described herein may have a suitable electrical resistance. In some embodiments, a fiber web has an electrical resistance of greater than or equal to 0 ohms*cm², greater than or equal to 0.1 ohm*cm², greater than or equal to 0.2 ohms*cm², greater than or equal to 0.3 ohms*cm², greater than or equal to 0.4 ohms*cm², greater than or equal to 0.5 ohms*cm², greater than or equal to 0.6 ohms*cm², greater than or equal to 0.7 ohms*cm², greater than or equal to 0.8 ohms*cm², greater than or equal to 1 ohm*cm², or greater than or equal to 1.25 ohms*cm². In some embodiments, a fiber web has an electrical resistance of less than or equal to 1.5 ohms*cm², less than or equal to 1.25 ohms*cm², less than or equal to 1 ohm*cm², less than or equal to 0.8 ohms*cm², less than or equal to 0.7 ohms*cm², less than or equal to 0.6 ohms*cm², less than or equal to 0.5 ohms*cm², less than or equal to 0.4 ohms*cm², less than or equal to 0.3 ohms*cm², less than or equal to 0.2 ohms*cm², or less than or equal to 0.1 ohm*cm². Combinations of the above-referenced ranges are also possible (e.g., greater than or equal to 0 ohms*cm² and less than or equal to 1.5 ohms*cm², greater than or equal to 0 ohms*cm² and less than or equal to 0.5 ohms*cm², or greater than or equal to 0 ohms*cm² and less than or equal to 0.3 ohms*cm²). Other ranges are also possible. In embodiments in which more than one fiber web is present, each fiber web may independently have an electrical resistance in one or more of the ranges described above. The electrical resistance of a fiber web may be determined in accordance with IS 6071-1986.

In some embodiments, a fiber web described herein has a relatively high break down voltage. As used herein, the breakdown voltage is the minimum voltage that, when applied across the fiber web, causes a portion of the fiber web to become electrically conductive. In general, the breakdown voltage is indicative of the dielectric strength of the dry fiber web. In general, the breakdown voltage of a fiber web without a short will be relatively high. However, a short (e.g., due to dendrite formation) will produce a relatively low breakdown voltage. A fiber web may have a break down voltage of greater than or equal to 0.1 kV, greater than or equal to 0.2 kV, greater than or equal to 0.3 kV, greater than or equal to 0.4 kV, greater than or equal to 0.5 kV, greater than or equal to 0.6 kV, greater than or equal to 0.7 kV, greater than or equal to 0.8 kV, greater than or equal to 0.9 kV, greater than or equal to 1 kV, greater than or equal to 2 kV, greater than or equal to 3 kV, greater than or equal to 4 kV, greater than or equal to 5 kV, greater than or equal to 6 kV, or greater than or equal to 8 kV. A fiber web may have a break down voltage of less than or equal to 10 kV, less than or equal to 8 kV, less than or equal to 6 kV, less than or equal to 5 kV, less than or equal to 4 kV, less than or equal to 3 kV, less than or equal to 2 kV, less than or equal to 1 kV, less than or equal to 0.9 kV, less than or equal to 0.8 kV, less than or equal to 0.7 kV, less than or equal to 0.6 kV, less than or equal to 0.5 kV, less than or equal to 0.4 kV, less than or equal to 0.3 kV, or less than or equal to 0.2 kV. Combinations of the above-referenced ranges are also possible (e.g., greater than or equal to 0.1 kV and less than or equal to 10 kV, greater than or equal to 0.5 kV and less than or equal to 5 kV, or greater than or equal to 0.8 kV and less than or equal to 3 kV). Other ranges are also possible. In embodiments in which more than one fiber web is present, each fiber web may independently have a break down voltage in one or more of the ranges described above.

Briefly, the breakdown voltage of a fiber web can be measured by applying 100 V, using 10 cm by 10 cm electrodes, across the fiber web and then increasing the voltage applied across the fiber web until a current of 18 mA is produced. The applied voltage at which 18 mA or more of current is first measured is the breakdown voltage.

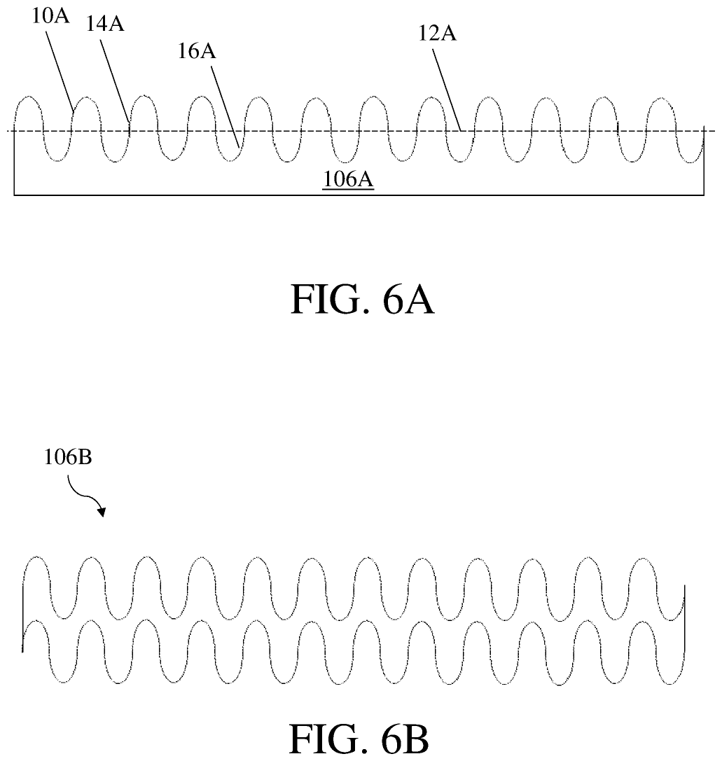

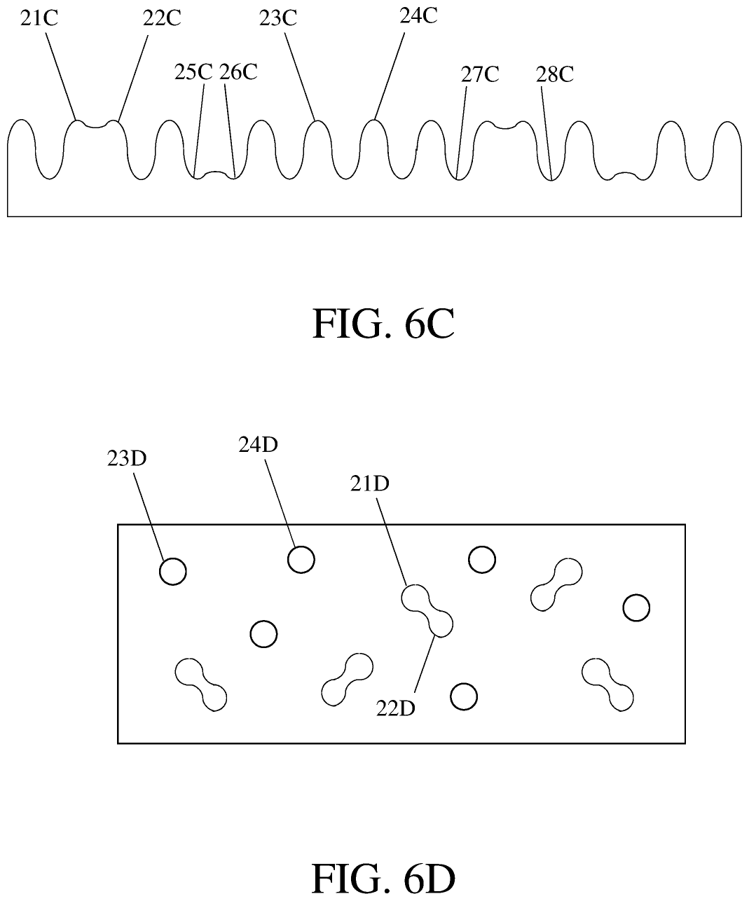

In some embodiments, a battery separator has a three-dimensional structure. The three-dimensional structure may include a surface comprising protrusions extending a midplane of the surface and/or depressions extending below the midplane of the surface. FIG. 6A shows one non-limiting embodiment of a battery separator 106A having one such surface, and FIG. 6B shows one non-limiting embodiment of a battery separator 106B having two such surfaces that are opposite each other. With reference to FIG. 6A, the upper surface 10A comprises a midplane 12A. Half of the surface 10A is above the midplane 12A and half of the surface 10A is below the midplane 12A. The portions of the surface 10A extending above the midplane 12A form protrusions 14A, and the portions of the surface 10A extending below the midplane 12A form depressions 16A.

It should be understood that FIGS. 6A and 6B are purely exemplary, and that other arrangements of protrusions and depressions with respect to a midplane are also possible. For instance, a surface may comprise protrusions that are discrete from each other (e.g., that form discrete peaks) and/or may comprise protrusions that are interconnected (e.g., protrusions that form a network spanning at least a portion of the fiber web, protrusions that are connected by a portion of the fiber web also extending above the midplane thereof). Similarly, a surface may comprise depressions that are discrete from each other (e.g., that form discrete troughs) and/or may comprise depressions that are interconnected (e.g., depressions that form a network spanning at least a portion of the fiber web, depressions that are connected by a portion of the fiber web also extending below the midplane thereof). By way of example, FIG. 6C depicts protrusions 21C and 22C that are interconnected with each other and protrusions 23C and 24C that are discrete from each other. FIG. 6C also depicts depressions 25C and 26C that are interconnected with each other and depressions 27C and 28C that are discrete from each other. As another example, FIG. 6D shows a top view of a battery separator showing protrusions 21D and 22D that are interconnected with each other and protrusions 23D and 24D that are discrete from each other.

In some embodiments, a surface comprises protrusions and/or depressions that form a repeating pattern, and, in some embodiments, a surface comprises protrusions and/or depressions that are randomly distributed across the surface. A surface may comprise protrusions and/or depressions may be relatively uniform in shape and/or magnitude, and/or may comprise protrusions and/or depressions that differ in shape and/or magnitude.

When a battery separator comprises two surfaces comprising protrusions and/or depressions, the protrusions and/or depressions on the two surfaces may be aligned (e.g., one surface may comprise a protrusion in a location that the opposing surface comprises a depression, two opposing surfaces may comprise protrusions in the same locations and/or comprise depressions in the same location), or may be unaligned. The protrusions and depressions in two surfaces of a battery separator may be similar in shape and/or magnitude, and/or may differ in shape and/or magnitude.

Three-dimensional structures, such as three-dimensional structures comprising protrusions extending above a midplane of a surface and/or depressions extending below a midplane of a surface, may be formed in a variety of suitable manners. In some embodiments, a shaping technique that allows the geometry of the battery separator to be controlled without negatively affecting another beneficial property of the battery separator (e.g., porosity) may be used. The three-dimensional structure of the layer may be altered during and/or after fabrication of the layer. Non-limiting examples of suitable processes include, but are not limited to, corrugation, pleating, embossing, creping, and micrexing.

In some embodiments, corrugation or pleating may be used to form a three-dimensional structure in a battery separator. The corrugation or pleating may be performed in the machine direction or cross direction. In some embodiments, corrugation or pleating may result in bends, curves, waves or pleats within the battery separator.

In some embodiments, embossing may be used to form a three-dimensional structure in a battery separator. Several different techniques may be used to emboss the layer. For example, pressure may be applied to a layer using a roll system to form surface features (e.g., indentations) having a specific pattern. In some instances, the battery separator may be formed on a wire (e.g., inclined table, flat table, rotoformer, round former) that has a mesh pattern. The mesh pattern may generate zones with more or less pulp and, accordingly, may produce an uneven thickness profile (e.g., indentations) across the battery separator. In some such embodiments, the indentations may be in the form of a mesh pattern, and may have a depth and/or a percent area coverage in the layer in one or more ranges described herein. In embodiments in which the battery separator is a wetlaid battery separator (e.g., it is a wetlaid fiber web), the battery separator may be embossed during the wet stage using a dandy roll with a defined pattern. An embossed battery separator may comprise repeated units of one or more shape (e.g., square indentations). The repeated units may have a defined shape, which may be, for example, substantially circular, square, rectangular, trapezoidal, polygonal, or oval in cross-section and/or in plan view (i.e., viewed from above). The shapes may be regular or irregular. Any suitable shape may be embossed onto the layer.

In some embodiments, the plurality of indentations in an embossed battery separator may be arranged to form a pattern. In some embodiments, the pattern of indentations may be simple, such as a checkerboard pattern, or more complex like a honeycomb pattern. In other cases, for example, the pattern may be cubic, hexagonal, and/or polygonal. The pattern of indentations may be regular or irregular.

In some embodiments, creping may be used to form a three-dimensional structure in a battery separator. In some embodiments, creping refers to the generation of a three-dimensional structure of a flat wet sheet using a quick change of speed and angle of the sheet path from a smooth roll. In some embodiments, creping may be used to form an irregular shape in the battery separator, such as an irregular wave pattern. In some embodiments, creping may be used to form a regular shape. In some embodiments, creping may result in bends, curves, waves or patterns within the battery separator.

In some embodiments, micrexing may be used to form a three-dimensional structure in a battery separator. Micrexing is similar to creping but is performed on a fully dried sheet. In some embodiments, micrexing may be used to form an irregular shape in the battery separator, such as an irregular wave pattern. In some embodiments, micrexing may be used to form a regular shape. In some embodiments, micrexing may result in bends, curves, waves or patterns within the battery separator.

It should be appreciated that while in some embodiments a layer may have a three-dimensional structure, e.g., it may be corrugated, pleated, embossed, creped, and/or micrexed, in some embodiments, a battery separator described herein is not corrugated, not pleated, not embossed, not creped, and/or not micrexed. Additionally, it should be understood that in some embodiments, more than one technique can be used to form a three-dimensional structure in a separator described herein (e.g., corrugation and embossing). The three-dimensional structure is typically formed prior to any formation of a larger-scale structure of the battery separator (e.g., prior to forming a flat sheet into a pocket separator, prior to folding a flat sheet to form a folded separator).

In some embodiments, protrusions extending above a surface of the separator may take the form of ribs. In general, the ribs may have any suitable shape and be arranged in any suitable pattern as described in PCT/IB/064420 filed Sep. 11, 2014, entitled Battery Separator with Ribs and a Method of Casting the Ribs on the Separator, which is incorporated herein by reference in its entirety. For example, the ribs may be in the form of lines (e.g., continuous, discontinuous) or dots arranged in rows on top of one or more layers of the battery separator. In some embodiments, ribs may not be present on the battery separator.

Non-limiting examples of suitable materials from which ribs may be formed include thermoplastics, such as plastisol (e.g., poly(vinyl chloride) blended with a plasticizer, poly(acrylate)s), poly(olefin)s (e.g., poly(ethylene), poly(propylene), poly(butylene), copoly(ethylene-octene), poly(ethylenevinylacetate)), poly(ester), poly(styrene), acrylonitrile-butadiene-styrene (ABS), poly(vinyl chloride), poly(imide)s, poly(urethane)s, and thermosets, such as poly(urethane)s, poly(acrylate)s, poly(epoxide)s, reactive plastisols, phenolic resin, poly(imide)s, rubber (e.g., natural, synthetic), and combinations thereof.

When a separator comprises protrusions extending above a midplane of a surface therein and/or depressions extending below the midplane of the surface therein, the average distance from the midplane of the surface to the protrusions and/or depressions may be a variety of suitable values. In some embodiments, an average distance from the midplane of the surface to the protrusions and/or depressions is greater than or equal to 0.1 mm, greater than or equal to 0.2 mm, greater than or equal to 0.3 mm, greater than or equal to 0.4 mm, greater than or equal to 0.5 mm, greater than or equal to 0.75 mm, greater than or equal to 1 mm, greater than or equal to 1.25 mm, or greater than or equal to 1.5 mm. In some embodiments, an average distance from the midplane of the surface to the protrusions and/or depressions is less than or equal to 2 mm, less than or equal to 1.5 mm, less than or equal to 1.25 mm, less than or equal to 1 mm, less than or equal to 0.75 mm, less than or equal to 0.5 mm, less than or equal to 0.4 mm, less than or equal to 0.3 mm, or less than or equal to 0.2 mm. Combinations of the above-referenced ranges are also possible (e.g., greater than or equal to 0.1 mm and less than or equal to 1.5 mm). Other ranges are also possible. As used herein, the distance from the midplane of the surface to a protrusion is the distance between the midplane of the surface and the point of the protrusion extending furthest from the midplane of the surface. Similarly, herein, the distance from the midplane of the surface to a depression is the distance between the midplane of the surface and the point of the depression extending furthest from the midplane of the surface.

When a separator comprises protrusions extending above a midplane of a surface therein and/or depressions extending below the midplane of the surface therein, the average nearest neighbor distance between protrusions and/or depressions may be a variety of suitable values. In some embodiments, an average nearest neighbor distance between the protrusions and/or depressions is greater than or equal to 0.1 mm, greater than or equal to 0.2 mm, greater than or equal to 0.5 mm, greater than or equal to 1 mm, greater than or equal to 2 mm, greater than or equal to 5 mm, greater than or equal to 7.5 mm, greater than or equal to 10 mm, greater than or equal to 12.5 mm, greater than or equal to 15 mm, greater than or equal to 20 mm, greater than or equal to 25 mm, greater than or equal to 30 mm, greater than or equal to 40 mm, greater than or equal to 50 mm, greater than or equal to 75 mm, or greater than or equal to 100 mm. In some embodiments, an average nearest neighbor distance between the protrusions and/or depressions is less than or equal to 200 mm, less than or equal to 100 mm, less than or equal to 75 mm, less than or equal to 50 mm, less than or equal to 40 mm, less than or equal to 30 mm, less than or equal to 25 mm, less than or equal to 20 mm, less than or equal to 15 mm, less than or equal to 12.5 mm, less than or equal to 10 mm, less than or equal to 7.5 mm, less than or equal to 5 mm, less than or equal to 2 mm, less than or equal to 1 mm, less than or equal to 0.5 mm, or less than or equal to 0.2 mm. Combinations of the above-referenced ranges are also possible (e.g., greater than or equal to 0.1 mm and less than or equal to 200 mm). Other ranges are also possible.

In some embodiments, a battery separator, such as a battery separator comprising a fiber web, may, as a whole, have one or more advantageous properties. It should be understood that a battery separator as a whole may have one or more properties falling within a range described elsewhere herein with respect to the fiber web (e.g., porosity, mean flow pore size, maximum pore size, basis weight, thickness, specific surface area, air permeability, contact angle, tensile strength, elongation at break, puncture strength, electrical resistance, break down voltage). This may occur, for instance, in the case where a battery separator includes only a single fiber web. It may also occur if the battery separator includes two fiber webs and/or one or more fiber webs and one or more further components in addition to the fiber web(s). Further values of particular values of some properties of battery separators are described in additional detail below.

The battery separators described herein may have a relatively high porosity. In some embodiments, a separator has a porosity of greater than or equal to 50% greater than or equal to 55%, greater than or equal to 60%, greater than or equal to 65%, greater than or equal to 70%, greater than or equal to 75%, greater than or equal to 80%, greater than or equal to 85%, greater than or equal to 90%, or greater than or equal to 95%. In some embodiments, a battery separator has a porosity of less than or equal to 99%, less than or equal to 95%, less than or equal to 90%, less than or equal to 85%, less than or equal to 80%, less than or equal to 75%, less than or equal to 70%, less than or equal to 65%, less than or equal to 60%, or less than or equal to 55%. Combinations of the above-referenced ranges are also possible (e.g., greater than or equal to 50% and less than or equal to 99%, greater than or equal to 70% and less than or equal to 95%, or greater than or equal to 80% and less than or equal to 90%). The porosity of the battery separator may be determined by following the procedure described above with respect to fiber webs for the battery separator.

The battery separators described herein may have a suitable basis weight. In some embodiments, a battery separator has a basis weight of greater than or equal to 2 g/m², greater than or equal to 5 g/m², greater than or equal to 10 g/m², greater than or equal to 20 g/m², greater than or equal to 30 g/m², greater than or equal to 40 g/m², greater than or equal to 50 g/m², greater than or equal to 60 g/m², greater than or equal to 70 g/m²,greater than or equal to 80 g/m², greater than or equal to 90 g/m², greater than or equal to 100 g/m², greater than or equal to 120 g/m², greater than or equal to 150 g/m², greater than or equal to 170 g/m², greater than or equal to 200 g/m², greater than or equal to 250 g/m², greater than or equal to 300 g/m², or greater than or equal to 400 g/m². In some embodiments, a battery separator has a basis weight of less than or equal to 500 g/m², less than or equal to 400 g/m², less than or equal to 300 g/m², less than or equal to 250 g/m², less than or equal to 200 g/m², less than or equal to 170 g/m², less than or equal to 150 g/m², less than or equal to 120 g/m², less than or equal to 100 g/m², less than or equal to 90 g/m², less than or equal to 80 g/m², less than or equal to 70 g/m², less than or equal to 60 g/m², less than or equal to 50 g/m², less than or equal to 40 g/m², less than or equal to 30 g/m², less than or equal to 20 g/m², less than or equal to 10 g/m², or less than or equal to 5 g/m². Combinations of the above-referenced ranges are also possible (e.g., greater than or equal to 2 g/m² and less than or equal to 500 g/m², greater than or equal to 80 g/m² and less than or equal to 250 g/m², greater than or equal to 90 g/m² and less than or equal to 170 g/m²). Other ranges are also possible. The basis weight of a battery separator may be determined in accordance with ISO 536:2012.

The battery separators described herein may have a suitable thickness. In some embodiments, a battery separator has a thickness of greater than or equal to 0.01 mm, greater than or equal to 0.02 mm, greater than or equal to 0.05 mm, greater than or equal to 0.075 mm, greater than or equal to 0.1 mm, greater than or equal to 0.2 mm, greater than or equal to 0.3 mm, greater than or equal to 0.4 mm, greater than or equal to 0.5 mm, greater than or equal to 0.6 mm, greater than or equal to 0.7 mm, greater than or equal to 0.8 mm, greater than or equal to 1 mm, greater than or equal to 1.3 mm, greater than or equal to 2 mm, greater than or equal to 3 mm, greater than or equal to 4 mm, greater than or equal to 5 mm, or greater than or equal to 7.5 mm. In some embodiments, a battery separator has a thickness of less than or equal to 10 mm, less than or equal to 7.5 mm, less than or equal to 5 mm, less than or equal to 4 mm, less than or equal to 3 mm, less than or equal to 2 mm, less than or equal to 1.3 mm, less than or equal to 1 mm, less than or equal to 0.8 mm, less than or equal to 0.7 mm, less than or equal to 0.6 mm, less than or equal to 0.5 mm, less than or equal to 0.4 mm, less than or equal to 0.3 mm, less than or equal to 0.2 mm, less than or equal to 0.1 mm, less than or equal to 0.075 mm, less than or equal to 0.05 mm, or less than or equal to 0.02 mm. Combinations of the above-referenced ranges are also possible (e.g., greater than or equal to 0.01 mm and less than or equal to 10 mm, greater than or equal to 0.4 mm and less than or equal to 2 mm, or greater than or equal to 0.7 mm and less than or equal to 1.3 mm). Other ranges are also possible. The thickness of a battery separator may be determined in accordance with CIS-03A, Sept-09, Method 10 under 10 kPa applied pressure.

The battery separators described herein may have a suitable apparent density. In some embodiments, a battery separator has an apparent density of greater than or equal to 40 gsm/mm, greater than or equal to 50 gsm/mm, greater than or equal to 60 gsm/mm, greater than or equal to 70 gsm/mm, greater than or equal to 80 gsm/mm, greater than or equal to 90 gsm/mm, greater than or equal to 100 gsm/mm, greater than or equal to 110 gsm/mm, greater than or equal to 120 gsm/mm, greater than or equal to 130 gsm/mm, greater than or equal to 150 gsm/mm, greater than or equal to 175 gsm/mm, greater than or equal to 200 gsm/mm, greater than or equal to 250 gsm/mm, greater than or equal to 300 gsm/mm, greater than or equal to 400 gsm/mm, or greater than or equal to 500 gsm/mm. In some embodiments, a battery separator has an apparent density of less than or equal to 600 gsm/mm, less than or equal to 500 gsm/mm, less than or equal to 400 gsm/mm, less than or equal to 300 gsm/mm, less than or equal to 250 gsm/mm, less than or equal to 200 gsm/mm, less than or equal to 175 gsm/mm, less than or equal to 150 gsm/mm, less than or equal to 130 gsm/mm, less than or equal to 120 gsm/mm, less than or equal to 110 gsm/mm, less than or equal to 100 gsm/mm, less than or equal to 90 gsm/mm, less than or equal to 80 gsm/mm, less than or equal to 70 gsm/mm, less than or equal to 60 gsm/mm, or less than or equal to 50 gsm/mm. Combinations of the above-referenced ranges are also possible (e.g., greater than or equal to 40 gsm/mm and less than or equal to 600 gsm/mm, greater than or equal to 40 gsm/mm and less than or equal to 200 gsm/mm, greater than or equal to 60 gsm/mm and less than or equal to 200 gsm/mm, or greater than or equal to 150 gsm/mm and less than or equal to 150 gsm/mm). Other ranges are also possible. The apparent density of a battery separator may be determined by finding the basis weight and thickness of the battery separator as described elsewhere herein, and then dividing the basis weight of the battery separator by the thickness of the battery separator. When a battery separator has a three-dimensional structure and/or comprises protrusions and/or ribs, the thickness of the battery separator should be understood to be the thickness of the three-dimensionally-structured battery separator (i.e., its thickness after being shaped to have the three-dimensional structure) and should include any protrusions (e.g., including any bends, curves, waves, pleats, and/or ribs).

In some embodiments, a battery separator exhibits a relatively high lifetime when an electrochemical oxidation test according to IS 6071-1986 is performed. This test comprises exposing the battery separator to overcharging conditions until the voltage drop across the battery separator is 0 V. Overcharging the battery causes oxygen to be evolved at the positive electrode, which causes the electrolyte to become oxidative. As the electrolyte becomes oxidative, the battery separator degrades and its electrical resistivity decreases. This causes the voltage drop across the battery separator to decrease. When the measured voltage drop across the battery separator is 0 V, it presents appreciably no resistance to current flow. The lifetime is the time elapsed between the beginning of the exposure of the battery separator to the overcharging conditions and the moment when the voltage drop across the battery separator is 0 V.

In some embodiments, a battery separator exhibits a lifetime of greater than or equal to 500 hours, greater than or equal to 600 hours, greater than or equal to 700 hours, greater than or equal to 800 hours, greater than or equal to 900 hours, greater than or equal to 1000 hours, greater than or equal to 2000 hours, greater than or equal to 3000 hours, greater than or equal to 4000 hours, greater than or equal to 5000 hours, greater than or equal to 6000 hours, greater than or equal to 7000 hours, greater than or equal to 8000 hours, or greater than or equal to 9000 hours when an electrochemical oxidation test according to IS 6071-1986 is performed. In some embodiments, a battery separator exhibits a lifetime of less than or equal to 10000 hours, less than or equal to 9000 hours, less than or equal to 8000 hours, less than or equal to 7000 hours, less than or equal to 6000 hours, less than or equal to 5000 hours, less than or equal to 4000 hours, less than or equal to 3000 hours, less than or equal to 2000 hours, less than or equal to 1000 hours, less than or equal to 900 hours, less than or equal to 800 hours, less than or equal to 700 hours, or less than or equal to 600 hours when an electrochemical oxidation test according to IS 6071-1986 is performed. Combinations of the above-referenced ranges are possible (e.g., greater than or equal to 500 hours and less than or equal to 10000 hours, greater than or equal to 700 hours and less than or equal to 10000 hours, or greater than or equal to 1000 hours and less than or equal to 10000 hours). Other ranges are also possible.

As described above, some embodiments relate to lead-acid batteries, such as lead-acid batteries comprising the battery separators described herein. However, the battery separators may also be used for other battery types and references to lead-acid batteries herein should be understood not to be limiting. Lead-acid batteries typically comprise a first battery plate (e.g., a negative battery plate) that comprises lead and a second battery plate (e.g., a positive battery plate) that comprises lead dioxide. During discharge, electrons pass from the first battery plate to the second battery plate while the lead paste in the first battery plate is oxidized to form lead sulfate and the lead dioxide in the second battery plate is reduced to also form lead sulfate. During charge, electrons pass from the second battery plate to the first battery plate while the lead sulfate in the first battery plate is reduced to form lead and the lead sulfate in the second battery plate is oxidized to form lead dioxide. Lead-acid batteries may further comprise an electrolyte (e.g., an electrolyte comprising sulfuric acid) that is configured to transport sulfate ions between the first and second battery plates during discharge in charge. One or more battery separators may be positioned between the first and second battery plates.

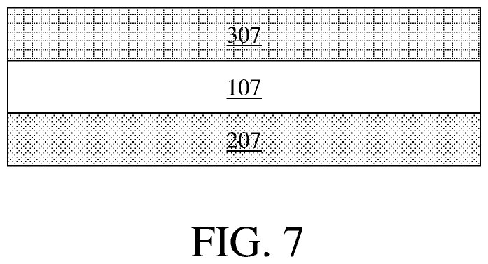

FIG. 7 shows one non-limiting embodiment of a lead-acid battery comprising a battery separator. In FIG. 7, the lead-acid battery comprises a battery separator 107 and battery plates 207 and 307. It should be understood that some embodiments may relate to lead-acid batteries comprising leaf separators (e.g., as shown in FIG. 7), and that some embodiments may relate to lead-acid batteries comprising other types of separators (e.g., folded separators, pocket separators). It should also be understood that some embodiments may relate to batteries comprising further components than those shown in FIG. 7 (e.g., a second separator, an electrolyte, an encasement, external wiring, etc.). Such components will be described in further detail below.

Some embodiments relate to a lead-acid battery that is a flooded battery, such as a flooded battery comprising one or more of the battery separators described herein. The flooded battery may be a conventional flooded battery, or may be an extended flooded battery. In some embodiments, a flooded battery is unsealed and exhausts gases produced therein (e.g., during discharge, during charge) to the environment surrounding the battery through one or more vents therein. These vents may, additionally or alternatively, allow acid, steam, condensation, and/or other species to flow into and/or out of the flooded battery. Extended flooded batteries may have several advantages in comparison to other types of lead-acid batteries. For instance, extended flooded batteries may exhibit more than twice the partial state of charge and deep-cycling performance of conventional lead-acid batteries, may be capable of providing power during a high number of engine starts and/or extended engine-off periods, may exhibit improved charge acceptance in comparison to conventional lead-acid batteries, may be designed to withstand hot environments (e.g., engine compartments, hot climates), and/or may be particularly suited for use in start-stop vehicle technologies with limited energy regeneration.

Battery plates described herein (e.g., first battery plates, negative battery plates, second battery plates, positive battery plates) typically comprise a battery paste disposed on a grid. A battery paste included in a first battery plate (e.g., a negative battery plate) may comprise lead, and/or may comprise both lead and lead dioxide (e.g., prior to full charging, during fabrication, battery assembly, and/or during one or more portions of a method described herein). A battery paste included in a second battery plate (e.g., a positive battery plate), may comprise lead dioxide, and/or may comprise both lead and lead dioxide (e.g., prior to full charging, during fabrication, during battery assembly, and/or during one or more portions of a method described herein). Grids (e.g., a grid included in a first battery plate, a grid included in a negative battery plate, a grid included in a second battery plate, a grid included in a positive battery plate), in some embodiments, include lead and/or a lead alloy.

In some embodiments, one or more battery plates (e.g., first battery plates, negative battery plates, second battery plates, positive battery plates) may further comprise one or more additional components. For instance, a battery plate may comprise a reinforcing material, such as an expander. When present, an expander may comprise barium sulfate, carbon black and lignin sulfonate as the primary components. The components of the expander(s) (e.g., carbon black and/or lignin sulfonate, if present, and/or any other components) can be pre-mixed or not pre-mixed. In some embodiments, a battery plate may comprise a commercially available expander, such as an expander produced by Hammond Lead Products (Hammond, Ind.) (e.g., a Texex® expander) or an expander produced by Atomized Products Group, Inc. (Garland, Tex.). Further examples of reinforcing materials include chopped organic fibers (e.g., having an average length of 0.125 inch or more), chopped glass fibers, metal sulfate(s) (e.g., nickel sulfate, copper sulfate), red lead (e.g., a Pb₃O₄-containing material), litharge, and paraffin oil.

It should be understood that while the additional components described above may be present in any combination of battery plates in a battery (e.g., in a first or negative battery plate and a second or positive battery plate, in a first or negative battery plate but not a second or positive battery plate, in a second or positive battery plate but not a first or negative battery plate, in no battery plates), some additional components may be especially advantageous for some types of battery plates. For instance, expanders, metal sulfates, and paraffins may be especially advantageous for use in second or positive battery plates. One or more of these components may be present in a second or positive battery plate, and absent in a first or negative battery plates. Some additional components described above may have utility in many types of battery plates (e.g., first battery plates, negative battery plates, second battery plates, positive battery plates). Non-limiting examples of such components include fibers (e.g., chopped organic fibers, chopped glass fibers). These components may, in some embodiments, be present in both first and second battery plates, and/or be present in both negative and positive battery plates.

Fiber webs (e.g., non-woven fiber webs) and battery separators described herein may be produced using suitable processes, such as a wetlaid process. In general, a wetlaid process involves mixing together fibers of one or more type; for example, a plurality of non-fibrillated synthetic fibers (e.g., acetate fibers) may be mixed together with a plurality of fibrillated fibers and/or a plurality of multicomponent fibers to provide a fiber slurry. The slurry may be, for example, an aqueous-based slurry. In some embodiments, fibers are optionally stored separately, or in combination, in various holding tanks prior to being mixed together.

For instance, each plurality of fibers or fiber type may be mixed and pulped together in separate containers. As an example, a plurality of non-fibrillated synthetic fibers may be mixed and pulped together in one container and a plurality of fibrillated synthetic fibers may be mixed and pulped in a second container. The pluralities of fibers may subsequently be combined together into a single fibrous mixture. Appropriate fibers may be processed through a pulper before and/or after being mixed together. In some embodiments, combinations of fibers are processed through a pulper and/or a holding tank prior to being mixed together. It can be appreciated that other components may also be introduced into the mixture. Furthermore, it should be appreciated that other combinations of fibers types may be used in fiber mixtures, such as the fiber types described herein.

In some embodiments, a fiber web may be formed by a wetlaid process. For example, in some embodiments, a single dispersion (e.g., a pulp) in a solvent (e.g., an aqueous solvent such as water) or slurry can be applied onto a wire conveyor in a papermaking machine (e.g., a fourdrinier or a rotoformer) to form a single layer supported by the wire conveyor. Vacuum may be continuously applied to the dispersion of fibers during the above process to remove the solvent from the fibers, thereby resulting in an article containing the single layer. In some embodiments, multiple layers may be formed simultaneously or sequentially in a wetlaid process. For instance, a first layer may be formed as described above, and then one or more layers may be formed on the first layer by following the same procedure. As an example, a dispersion in a solvent or slurry may be applied to a first layer on a wire conveyor, and vacuum applied to the dispersion or slurry to form a second layer on the first layer. Further layers may be formed on the first layer and the second layer by following this same process.

Any suitable method for creating a fiber slurry may be used. In some embodiments, further additives are added to the slurry to facilitate processing. The temperature may also be adjusted to a suitable range, for example, between 33° F. and 140° F. (e.g., between 50° F. and 85° F.). In some cases, the temperature of the slurry is maintained. In some instances, the temperature is not actively adjusted.

In some embodiments, the wetlaid process uses similar equipment as in a conventional papermaking process, for example, a hydropulper, a former or a headbox, a dryer, and an optional converter. A fiber web and/or battery separator can also be made with a laboratory handsheet mold in some instances. As discussed above, the slurry may be prepared in one or more pulpers. After appropriately mixing the slurry in a pulper, the slurry may be pumped into a headbox where the slurry may or may not be combined with other slurries. Other additives may or may not be added. The slurry may also be diluted with additional water such that the final concentration of fiber is in a suitable range, such as for example, between about 0.1% and 0.5% by weight.

In some cases, the pH of the fiber slurry may be adjusted as desired. For instance, fibers of the slurry may be dispersed under acidic or neutral conditions.

Before the slurry is sent to a headbox, the slurry may optionally be passed through centrifugal cleaners and/or pressure screens for removing undesired material (e.g., unfiberized material). The slurry may or may not be passed through additional equipment such as refiners or deflakers to further enhance the dispersion of the fibers. For example, deflakers may be useful to smooth out or remove lumps or protrusions that may arise at any point during formation of the fiber slurry. Fibers may then be collected on to a screen or wire at an appropriate rate using any suitable equipment, e.g., a fourdrinier, a rotoformer, or an inclined wire fourdrinier.

In some embodiments, a non-wetlaid process, such as an airlaid or carding process, may be used to form a fiber web (e.g., a non-woven fiber web) and/or a battery separator. For example, a fiber web may be formed by blowing fibers onto a conveyor in an airlaying process. As another example, a fiber web may be formed by a carding process in which fibers are manipulated by rollers and extensions (e.g., hooks, needles) associated with the rollers.

In some embodiments, one or more further processes may be performed after formation of a fiber web (e.g., to form an additional layer on a fiber web, to incorporate one or more further components into the fiber web). For instance, the fiber web may be exposed to a slurry comprising one or more components (e.g., particles of one or more types). The fiber web may be immersed in the slurry and/or the slurry may be deposited onto the fiber web. After exposure of the fiber web to the slurry, excess amounts of the slurry can be removed.

As another example of a further process, a portion (or all) of the water remaining in the fiber web may be removed. This may be accomplished by drying the fiber web until it has a desired wt % of moisture. In some embodiments, a fiber web is dried by use of an oven, dryer cans, and/or a Yankee dryer.

As a third example, a fiber web may be calendered. Calendering the fiber web may comprise compressing the fiber web using calender rolls while translating the fiber web. In some embodiments, the pressure applied by the calender rolls is between 500 psi and 800 psi (e.g., between 550 psi and 750 psi, between 550 psi and 700 psi, between 550 psi and 650 psi, between 550 and 600 psi, between 600 psi and 750 psi, between 600 psi and 700 psi, between 650 psi and 750 psi, between 700 psi and 750 psi); the temperature of the calender rolls is between 40° C. and 120° C. (e.g., between 40° C. and 85° C., between 50° C. and 85° C., between 60° C. and 85° C., between 65° C. and 75° C., between 70° C. and 85° C., between 35° C. and 80° C., between 35° C. and 70° C., between 35° C. and 60° C., between 35° C. and 50° C.); and/or the fiber web is translated at a line speed of between 5 ft/min and 100 ft/min (e.g., between 5 ft/min and 80 ft/min, between 10 ft/min and 50 ft/min, between 15 ft/min and 100 ft/min, between 15 ft/min and 25 ft/min, or between 20 ft/min and 90 ft/min). Other ranges for pressure, temperature, and line speed are also possible.

After formation of a battery separator, a battery comprising the battery separator may be assembled. The final, assembled battery may further comprise other components, such as first and second battery plates. These components may be placed in an external casing, and, optionally compressed. If compressed, the thickness of one or more battery components may be reduced. Then, an electrolyte, such as 1.28 spg sulfuric acid, may be added to the battery.

After assembly, the battery may undergo a formation step, during which the battery becomes fully charged and ready for operation. Formation may involve passing an electric current through an assembly of alternating negative and positive battery plates separated by separators. During formation, the battery paste in the negative and positive battery plates may be converted into negative and positive active materials, respectively. For example, lead dioxide in a battery paste disposed on the negative battery plate may be transformed into lead, and/or lead in a battery paste disposed on the positive battery plate may be transformed into lead dioxide.

### EXAMPLE 1

This Example describes the fabrication and characterization of four battery separators that may be suitable for use in extended flooded battery applications. The separators have a high porosity, high puncture and tensile strengths, and are formed from components that do not exhibit appreciable leaching in lead-acid batteries.

Battery separators A-C were fabricated by wetlaying a mixture of synthetic fibrillated fibers and synthetic bicomponent fibers to form non-woven fibers webs. Battery separator D was fabricated by wetlaying a mixture of synthetic fibrillated fibers, synthetic bicomponent fibers, and poly(ester) fibers. The synthetic fibrillated fibers had an average length of 0.9 mm and an average parent fiber diameter of 5 microns. The synthetic bicomponent fibers had an average length of 6 mm and an average diameter of 10-13 microns. The poly(ester) fibers had an average length of 3 mm and an average diameter of 2.5 microns. Table 1, below, shows the relative amounts of each fiber type in the battery separators. Table 2, below, shows selected physical properties of the battery separators.

Battery Separator E was fabricated by carding and then thermally bonding a mixture of synthetic bicomponent fibers and poly(ester) fibers. The synthetic bicomponent fibers had an average length of 38 mm and an average diameter of 12-13 microns. The polyester fibers had an average length of 3 mm and an average diameter of 2.5 microns.

TABLE 1

| | Wt % Synthetic | Wt % Synthetic | |
|---|---|---|---|
| | fibrillated | bicomponent | Wt % Poly(ester) |
| | fibers | fibers | fibers |
| Battery Separator A | 87.6 | 12.4 | 0 |
| Battery Separator B | 90.4 | 9.6 | 0 |
| Battery Separator C | 95.5 | 4.5 | 0 |
| Battery Separator D | 81.8 | 2.2 | 16.1 |
| Battery Separator E | 0 | 30 | 70 |

TABLE 2

| | Battery | Battery | Battery | Battery | Battery |
|---|---|---|---|---|---|
| | Sepa- | Sepa- | Sepa- | Sepa- | Sepa- |
| | rator A | rator B | rator C | rator D | rator E |
| Basis weight | 131 | 130 | 175 | 151 | 110 |
| (g/m²) | | | | | |
| Thickness (mm) | 0.44 | 0.46 | 0.72 | 0.85 | 0.17 |
| Apparent density | 297 | 282 | 243 | 178 | 647 |
| (gsm/mm) | | | | | |
| Air permeability | 0.66 | 1.12 | 0.89 | 1.52 | 10 |
| (CFM) | | | | | |
| Mean flow pore | 3.09 | 3.43 | 3.41 | 3.6 | 11 |
| size (microns) | | | | | |
| Maximum pore | 9.75 | 10.89 | 10.41 | 10.2 | 34 |
| size (microns) | | | | | |
| Puncture strength | 25.9 | 23.45 | 24.3 | 26.1 | 35 |
| (N) | | | | | |
| Tensile strength | 16.4 | 11.8 | 14.71 | 15.2 | 42 |
| (lbs/inch) | | | | | |
| Porosity (%) | 71.03 | 71.87 | 75 | 80.82 | 58 |

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A lead-acid battery, comprising:
a battery separator; and
a battery plate, wherein:
the battery separator comprises a non-woven fiber web comprising synthetic fibers,
the synthetic fibers make up greater than 80 wt % of the non-woven fiber web,
the synthetic fibers comprise non-continuous fibers having an average length of greater than or equal to 0.1 mm and less than or equal to 300 mm,
the battery separator has an apparent density of greater than or equal to 40 gsm/mm and less than or equal to 200 gsm/mm,
the battery separator has a porosity of greater than or equal to 70%, and
the battery separator has a mean flow pore size of greater than or equal to 1 micron and less than or equal to 15 microns.

2. A lead-acid battery, comprising:
a battery separator; and
a battery plate, wherein:
the battery separator comprises a non-woven fiber web comprising synthetic fibers,
the synthetic fibers comprise non-continuous fibers having an average length of greater than or equal to 0.1 mm and less than or equal to 300 mm,
the battery separator has a puncture strength of greater than 20 N,
the battery separator has a porosity of greater than or equal to 70%,
the battery separator has a mean flow pore size of greater than or equal to 1 micron and less than or equal to 15 microns.

3. A lead-acid battery, comprising:
a battery separator; and
a battery plate, wherein
the battery separator comprises a non-woven fiber web comprising synthetic fibers,
the synthetic fibers comprise non-continuous fibers having an average length of greater than or equal to 0.1 mm and less than or equal to 300 mm,
the non-woven fiber web comprises fibrillated fibers,
the battery separator has a porosity of greater than or equal to 70%, and
the battery separator has a mean flow pore size of greater than or equal to 1 micron and less than or equal to 15 microns.

4. A lead-acid battery, comprising:
a battery separator; and
a battery plate, wherein
the battery separator comprises a non-woven fiber web comprising synthetic fibers,
the synthetic fibers comprise multicomponent fibers,
the synthetic fibers make up greater than 80 wt % of the non-woven fiber web,
the synthetic fibers comprise non-continuous fibers having an average length of greater than or equal to 0.1 mm and less than or equal to 300 mm,
the battery separator has a porosity of greater than or equal to 70%, and
the battery separator has a mean flow pore size of greater than or equal to 1 micron and less than or equal to 15 microns.

5-6. (canceled)

7. The lead-acid battery of claim 1, wherein the lead-acid battery is a flooded battery.

8. (canceled)

9. The lead-acid battery of claim 1, wherein the non-woven fiber web comprises multicomponent fibers.

10. (canceled)

11. The lead-acid battery of claim 1, wherein the wherein the non-woven fiber web comprises non-fibrillated fibers.

12. (canceled)

13. The lead-acid battery of claim 1, wherein non-fibrillated synthetic fibers make up greater than or equal to 5 wt % and less than or equal to 45 wt % of the non-woven fiber web.

14. The lead-acid battery of claim 1, wherein the synthetic fibers comprise fibrillated fibers.

15. The lead-acid battery of claim 14, wherein fibrillated fibers make up greater than or equal to 55 wt % and less than or equal to 95 wt % of the fiber web.

16. The lead-acid battery of claim 1, wherein the non-woven fiber web comprises particles.

17. The lead-acid battery of claim 1, wherein glass fibers make up less than or equal to 20 wt % of the non-woven fiber web.

18. The lead-acid battery of claim 1, wherein synthetic fibers comprise crimped fibers.

19. The lead-acid battery of claim 1, wherein the non-woven fiber web comprises natural fibers.

20. (canceled)

21. The lead-acid battery of claim 1, wherein resin makes up less than or equal to 20 wt % of the non-woven fiber web.

22. The lead-acid battery of claim 1, wherein the battery separator has a thickness of greater than or equal to 0.4 mm and less than or equal to 2 mm.

23. (canceled)

24. The lead-acid battery of claim 1, wherein the battery separator has an apparent density of greater than or equal to 60 gsm/mm and less than or equal to 200 gsm/mm.

25. The lead-acid battery of claim 1, wherein the battery separator has a maximum pore size of greater than or equal to 8 microns and less than or equal to 25 microns.

26-45. (canceled)

46. The lead-acid battery of claim 1, wherein the battery separator is embossed, creped, corrugated, micrexed, waved and/or pleated.

47. (canceled)

48. The lead-acid battery of claim 1, wherein the battery separator comprises ribs and/or dots.

49-56. (canceled)
